(19) United States
(12) Patent Application Publication
(10) Pub. No.: US 2022/0086869 A1
(43) Pub. Date: Mar. 17, 2022

(54) SEMI-PERSISTENT SCHEDULING OF SIDELINK COMMUNICATIONS

(71) Applicant: QUALCOMM Incorporated, San Diego, CA (US)

(72) Inventors: Lik Hang Silas Fong, Bridgewater, NJ (US); Piyush Gupta, Bridgewater, NJ (US); Jing Sun, San Diego, CA (US); Xiaojie Wang, Hillsborough, NJ (US)

(21) Appl. No.: 17/468,363

(22) Filed: Sep. 7, 2021

Related U.S. Application Data
(60) Provisional application No. 63/079,124, filed on Sep. 16, 2020.

(51) Int. Cl. H04W 72/12; H04W 72/04; H04W 24/08; H04L 1/18

(52) U.S. Cl. CPC H04W 72/1263; H04L 1/1896; H04W 24/08; H04W 72/0406

(57) ABSTRACT

Methods, systems, and devices for wireless communications are described. For example, a method for wireless communications at a transmitting user equipment (UE) may include receiving, from a base station, a resource configuration of sidelink communications. The transmitting UE may transmit, to a receiving UE, sidelink control information (SCI) via one or more SCI messages, the SCI comprising one or more semi-persistent scheduling indications pertaining to a semi-persistent scheduling configuration for communications from the transmitting UE to the receiving UE. The transmitting UE may monitor for feedback information pertaining to the SCI prior to proceeding with semi-persistent scheduled sidelink transmissions in accordance with the one or more semi-persistent scheduling indications.

### CROSS REFERENCE

The present Application for Patent claims the benefit of U.S. Provisional Patent Application No. 63/079,124 by FONG et al., entitled “SEMI-PERSISTENT SCHEDULING OF SIDELINK COMMUNICATIONS,” filed Sep. 16, 2020, assigned to the assignee hereof, and expressly incorporated by reference herein.

### FIELD OF TECHNOLOGY

The following relates generally to wireless communications and more specifically to semi-persistent scheduling (SPS) of sidelink communications.

### BACKGROUND

Wireless communications systems are widely deployed to provide various types of communication content such as voice, video, packet data, messaging, broadcast, and so on. These systems may be capable of supporting communication with multiple users by sharing the available system resources (e.g., time, frequency, and power). Examples of such multiple-access systems include fourth generation (4G) systems such as Long Term Evolution (LTE) systems, LTE-Advanced (LTE-A) systems, or LTE-A Pro systems, and fifth generation (5G) systems which may be referred to as New Radio (NR) systems. These systems may employ technologies such as code division multiple access (CDMA), time division multiple access (TDMA), frequency division multiple access (FDMA), orthogonal frequency division multiple access (OFDMA), or discrete Fourier transform spread orthogonal frequency division multiplexing (DFT-S-OFDM). A wireless multiple-access communications system may include one or more base stations or one or more network access nodes, each simultaneously supporting communication for multiple communication devices, which may be otherwise known as user equipment (UE).

In some wireless communications systems, UEs may communicate over a sidelink, such as a PC5 link. In some cases, scheduling of the sidelink resources may be controlled by a base station, or in other cases, a UE may control the scheduling. In some examples, sidelink communications may be used in an industrial internet of things (IoT) system, which may have periodic traffic. As PC5 link usage increases, it may be desirable to allow periodic traffic to be efficiently scheduled, by a UE or base station, and transmitted with improved techniques.

### SUMMARY

The described techniques relate to improved methods, systems, devices, and apparatuses that support semi-persistent scheduling (SPS) of sidelink communications. Generally, the described techniques provide for a user equipment (UE) to configure SPS communications with another UE, which may include the ability to reduce the transmission of sidelink control information (SCI). Thus, overhead signaling of sidelink communications may be reduced and communication efficiency may be improved. For example, a transmitting UE may receive, from a base station, a resource configuration for sidelink communications. The transmitting UE may then transmit, to a receiving UE, SCI via a first SCI message (e.g., SCI 0-1) and a second SCI message (e.g., SCI 0-2), the SCI may include one or more SPS indications pertaining to an SPS configuration for communications from the transmitting UE to the receiving UE.

For example, SPS indications may include one or more of an activation or deactivation indicator in either the first SCI message or the second SCI message, a configuration index in the second SCI message, and an SPS identifier in the first SCI message. The transmitting UE may then monitor for feedback information from the receiving UE pertaining to the SCI prior to proceeding with SPS sidelink transmissions in accordance with the one or more SPS indications. For example, a feedback message may indicate that the SPS configuration is active based on the SCI comprising the one or more SPS indications. As a result, future sidelink communications may be made according to the SPS configuration and in some cases, may need not be accompanied by one or both of the SCI messages.

A method for wireless communications at a transmitting user equipment (UE) is described. The method may include receiving, from a base station, a resource configuration of sidelink communications, transmitting, to a receiving UE, SCI via one or more SCI messages, the SCI including one or more SPS indications pertaining to a SPS configuration for communications from the transmitting UE to the receiving UE based on the resource configuration, and monitoring for feedback information pertaining to the SCI prior to proceeding with semi-persistent scheduled sidelink transmissions in accordance with the one or more SPS indications.

An apparatus for wireless communications at a transmitting UE is described. The apparatus may include a processor, memory coupled with the processor, and instructions stored in the memory. The instructions may be executable by the processor to cause the apparatus to receive, from a base station, a resource configuration of sidelink communications, transmit, to a receiving UE, SCI via one or more SCI messages, the SCI including one or more SPS indications pertaining to a SPS configuration for communications from the transmitting UE to the receiving UE based on the resource configuration, and monitor for feedback information pertaining to the SCI prior to proceeding with semi-persistent scheduled sidelink transmissions in accordance with the one or more SPS indications.

Another apparatus for wireless communications at a transmitting UE is described. The apparatus may include means for receiving, from a base station, a resource configuration of sidelink communications, means for transmitting, to a receiving UE, SCI via one or more SCI messages, the SCI including one or more SPS indications pertaining to a SPS configuration for communications from the transmitting UE to the receiving UE based on the resource configuration, and means for monitoring for feedback information pertaining to the SCI prior to proceeding with semi-persistent scheduled sidelink transmissions in accordance with the one or more SPS indications.

A non-transitory computer-readable medium storing code for wireless communications at a transmitting UE is described. The code may include instructions executable by a processor to receive, from a base station, a resource configuration of sidelink communications, transmit, to a receiving UE, SCI via one or more SCI messages, the SCI including one or more SPS indications pertaining to a SPS configuration for communications from the transmitting UE to the receiving UE based on the resource configuration, and monitor for feedback information pertaining to the SCI prior to proceeding with semi-persistent scheduled sidelink transmissions in accordance with the one or more SPS indications.

A method of wireless communications at a transmitting UE is described. The method may include receiving, from a base station, a resource configuration for sidelink communications, transmitting, to a receiving UE, SCI via a first SCI message and a second SCI message, the SCI including one or more SPS indications pertaining to a SPS configuration for communications from the transmitting UE to the receiving UE based on the resource configuration, and monitoring for feedback information pertaining to the SCI prior to proceeding with semi-persistent scheduled sidelink transmissions in accordance with the one or more SPS indications.

An apparatus for wireless communications at a transmitting UE is described. The apparatus may include a processor, memory coupled with the processor, and instructions stored in the memory. The instructions may be executable by the processor to cause the apparatus to receive, from a base station, a resource configuration for sidelink communications, transmit, to a receiving UE, SCI via a first SCI message and a second SCI message, the SCI including one or more SPS indications pertaining to a SPS configuration for communications from the transmitting UE to the receiving UE based on the resource configuration, and monitor for feedback information pertaining to the SCI prior to proceeding with semi-persistent scheduled sidelink transmissions in accordance with the one or more SPS indications.

Another apparatus for wireless communications at a transmitting UE is described. The apparatus may include means for receiving, from a base station, a resource configuration for sidelink communications, transmitting, to a receiving UE, SCI via a first SCI message and a second SCI message, the SCI including one or more SPS indications pertaining to a SPS configuration for communications from the transmitting UE to the receiving UE based on the resource configuration, and monitoring for feedback information pertaining to the SCI prior to proceeding with semi-persistent scheduled sidelink transmissions in accordance with the one or more SPS indications.

A non-transitory computer-readable medium storing code for wireless communications at a transmitting UE is described. The code may include instructions executable by a processor to receive, from a base station, a resource configuration for sidelink communications, transmit, to a receiving UE, SCI via a first SCI message and a second SCI message, the SCI including one or more SPS indications pertaining to a SPS configuration for communications from the transmitting UE to the receiving UE based on the resource configuration, and monitor for feedback information pertaining to the SCI prior to proceeding with semi-persistent scheduled sidelink transmissions in accordance with the one or more SPS indications.

A method of wireless communications at a receiving UE is described. The method may include receiving, from a transmitting UE on a sidelink channel, SCI including a first SCI message and a second SCI message, the SCI including one or more SPS indications pertaining to a SPS configuration for communications from the transmitting UE to the receiving UE and transmitting, to the transmitting UE, feedback information associated with the SCI.

An apparatus for wireless communications at a receiving UE is described. The apparatus may include a processor, memory coupled with the processor, and instructions stored in the memory. The instructions may be executable by the processor to cause the apparatus to receive, from a transmitting UE on a sidelink channel, SCI including a first SCI message and a second SCI message, the SCI including one or more SPS indications pertaining to a SPS configuration for communications from the transmitting UE to the receiving UE and transmit, to the transmitting UE, feedback information associated with the SCI.

Another apparatus for wireless communications at a receiving UE is described. The apparatus may include means for receiving, from a transmitting UE on a sidelink channel, SCI including a first SCI message and a second SCI message, the SCI including one or more SPS indications pertaining to a SPS configuration for communications from the transmitting UE to the receiving UE and transmitting, to the transmitting UE, feedback information associated with the SCI.

A non-transitory computer-readable medium storing code for wireless communications at a receiving UE is described. The code may include instructions executable by a processor to receive, from a transmitting UE on a sidelink channel, SCI including a first SCI message and a second SCI message, the SCI including one or more SPS indications pertaining to a SPS configuration for communications from the transmitting UE to the receiving UE and transmit, to the transmitting UE, feedback information associated with the SCI.

### BRIEF DESCRIPTION OF THE DRAWINGS

FIG. 1 illustrates an example of a wireless communications system that supports semi-persistent scheduling (SPS) of sidelink communications in accordance with aspects of the present disclosure.

FIG. 2 illustrates an example of a wireless communications system that supports SPS of sidelink communications in accordance with aspects of the present disclosure.

FIG. 3 illustrates an example of a sidelink mode that supports SPS of sidelink communications in accordance with aspects of the present disclosure.

FIG. 4 illustrates an example of a sidelink mode that supports SPS of sidelink communications in accordance with aspects of the present disclosure.

FIG. 5 illustrates an example of a process flow that supports SPS of sidelink communications in accordance with aspects of the present disclosure.

FIG. 6 illustrates an example of a process flow that supports SPS of sidelink communications in accordance with aspects of the present disclosure.

FIGS. 7 and 8 show block diagrams of devices that support SPS of sidelink communications in accordance with aspects of the present disclosure.

FIG. 9 shows a block diagram of a communications manager that supports SPS of sidelink communications in accordance with aspects of the present disclosure.

FIG. 10 shows a diagram of a system including a device that supports SPS of sidelink communications in accordance with aspects of the present disclosure.

FIGS. 11 through 20 show flowcharts illustrating methods that support SPS of sidelink communications in accordance with aspects of the present disclosure.

### DETAILED DESCRIPTION

The described techniques relate to improved methods, systems, devices, and apparatuses that support semi-persistent scheduling (SPS) of sidelink communications. Generally, the described techniques provide for a user equipment (UE) to configure SPS communications with another UE, which may include the ability to reduce the transmission of sidelink control information (SCI). Sidelink communications may involve a transmitting UE sending SCI in a physical sidelink control channel (PSCCH) via two separate SCI messages (e.g., SCI 0-1 message and SCI 0-2 message). The SCI 0-1 message may be transmitted first, followed by the SCI 0-2 message. The SCI may be followed by a data transmission on a physical sidelink shared channel (PSSCH). In some cases, the traffic in industrial internet of things (IoT) systems may generally be periodic and predetermined between controllers and sensors or actuators. As such, IoT communications systems may benefit from the use of SPS communications. Configured grants in sidelink systems may conventionally rely on base station configuration, and configured grant-related information may not traditionally be included within the transmitted SCI messages.

According to the techniques described herein, a transmitting UE that has been granted resources by a base station for SPS may both utilize the SCI messages to convey SPS-related information and also allow for SCI messages to not be transmitted when an SPS configuration is active. For example, a transmitting UE may use one or more SCI messages to convey a number of different SPS indicators at the time of a first PSCCH transmission and optional PSSCH transmission. For instance, an indicator may be an identifier that the SCI messages carry SPS information, and the identifier may be included in an SCI 0-1 message or may be used to scramble the SCI 0-1. Another indicator may be an SPS activation/deactivation indicator, indicating that an SPS configuration is either activated or deactivated. This activation/deactivation indicator may be included in either SCI 0-1 or SCI 0-2. A third indicator may be an SPS configuration index, which may be carried in SCI 0-2.

Once a transmitting UE conveys the SPS information in the one or more SCI messages, the transmitting UE may monitor for feedback from the receiving UE to determine if the SPS information was received and thus, if the SPS configuration is active. If the transmitting UE receives a positive acknowledgement (ACK) from a receiving UE, then future PSSCH transmissions made according to the SPS configuration may need not be accompanied by one or both of the SCI messages. If the transmitting UE receives a negative acknowledgement (NACK) from a receiving UE, then the transmitting UE may determine the SPS configuration is active and may also retransmit the unsuccessfully received PSSCH transmission that may need not be accompanied by one or both of the SCI messages. In some examples, the retransmission may be made according to the SPS configuration, or in other examples, the retransmission may be made on dynamically granted resources.

Aspects of the disclosure are initially described in the context of wireless communications systems. Aspects of the disclosure are further illustrated by and described with reference to apparatus diagrams, system diagrams, process flows, and flowcharts that relate to SPS of sidelink communications.

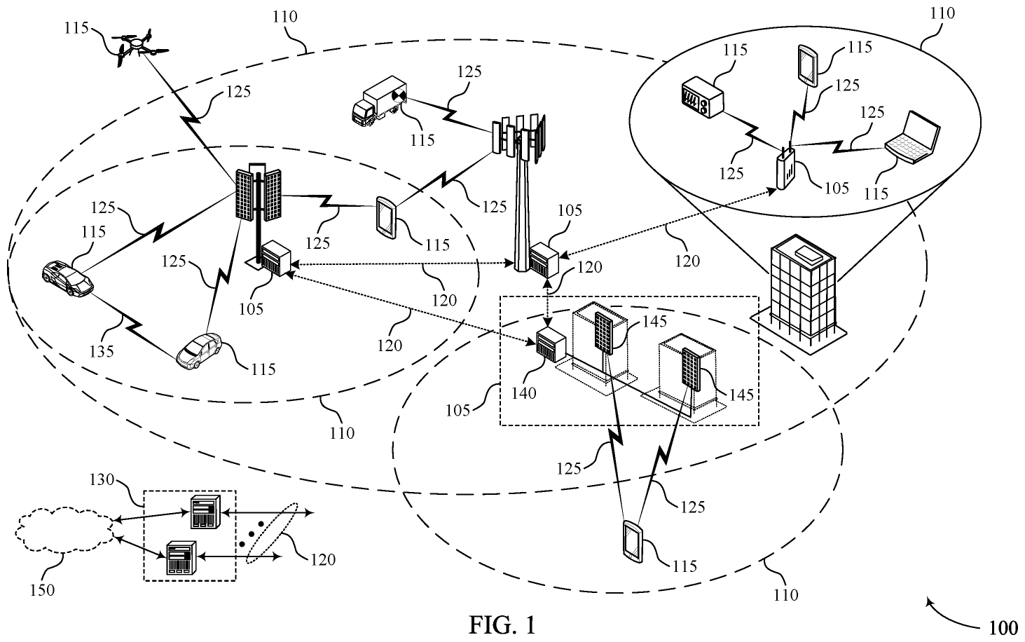

FIG. 1 illustrates an example of a wireless communications system 100 that supports SPS of sidelink communications in accordance with aspects of the present disclosure. The wireless communications system 100 may include one or more base stations 105, one or more UEs 115, and a core network 130. In some examples, the wireless communications system 100 may be a Long Term Evolution (LTE) network, an LTE-Advanced (LTE-A) network, an LTE-A Pro network, or a New Radio (NR) network. In some examples, the wireless communications system 100 may support enhanced broadband communications, ultra-reliable (e.g., mission critical) communications, low latency communications, communications with low-cost and low-complexity devices, or any combination thereof

The base stations 105 may be dispersed throughout a geographic area to form the wireless communications system 100 and may be devices in different forms or having different capabilities. The base stations 105 and the UEs 115 may wirelessly communicate via one or more communication links 125. Each base station 105 may provide a coverage area 110 over which the UEs 115 and the base station 105 may establish one or more communication links 125. The coverage area 110 may be an example of a geographic area over which a base station 105 and a UE 115 may support the communication of signals according to one or more radio access technologies.

The UEs 115 may be dispersed throughout a coverage area 110 of the wireless communications system 100, and each UE 115 may be stationary, or mobile, or both at different times. The UEs 115 may be devices in different forms or having different capabilities. Some example UEs 115 are illustrated in FIG. 1. The UEs 115 described herein may be able to communicate with various types of devices, such as other UEs 115, the base stations 105, or network equipment (e.g., core network nodes, relay devices, integrated access and backhaul (IAB) nodes, or other network equipment), as shown in FIG. 1.

The base stations 105 may communicate with the core network 130, or with one another, or both. For example, the base stations 105 may interface with the core network 130 through one or more backhaul links 120 (e.g., via an S1, N2, N3, or other interface). The base stations 105 may communicate with one another over the backhaul links 120 (e.g., via an X2, Xn, or other interface) either directly (e.g., directly between base stations 105), or indirectly (e.g., via core network 130), or both. In some examples, the backhaul links 120 may be or include one or more wireless links.

One or more of the base stations 105 described herein may include or may be referred to by a person having ordinary skill in the art as a base transceiver station, a radio base station, an access point, a radio transceiver, a NodeB, an eNodeB (eNB), a next--generation NodeB or a giga-NodeB (either of which may be referred to as a gNB), a Home NodeB, a Home eNodeB, or other suitable terminology.

A UE 115 may include or may be referred to as a mobile device, a wireless device, a remote device, a handheld device, or a subscriber device, or some other suitable terminology, where the “device” may also be referred to as a unit, a station, a terminal, or a client, among other examples. A UE 115 may also include or may be referred to as a personal electronic device such as a cellular phone, a personal digital assistant (PDA), a tablet computer, a laptop computer, or a personal computer. In some examples, a UE 115 may include or be referred to as a wireless local loop (WLL) station, an IoT device, an Internet of Everything (IoE) device, or a machine type communications (MTC) device, among other examples, which may be implemented in various objects such as appliances, or vehicles, meters, among other examples.

The UEs 115 described herein may be able to communicate with various types of devices, such as other UEs 115 that may sometimes act as relays as well as the base stations 105 and the network equipment including macro eNBs or gNBs, small cell eNBs or gNBs, or relay base stations, among other examples, as shown in FIG. 1.

The UEs 115 and the base stations 105 may wirelessly communicate with one another via one or more communication links 125 over one or more carriers. The term “carrier” may refer to a set of radio frequency spectrum resources having a defined physical layer structure for supporting the communication links 125. For example, a carrier used for a communication link 125 may include a portion of a radio frequency spectrum band (e.g., a bandwidth part (BWP)) that is operated according to one or more physical layer channels for a given radio access technology (e.g., LTE, LTE-A, LTE-A Pro, NR). Each physical layer channel may carry acquisition signaling (e.g., synchronization signals, system information), control signaling that coordinates operation for the carrier, user data, or other signaling. The wireless communications system 100 may support communication with a UE 115 using carrier aggregation or multi-carrier operation. A UE 115 may be configured with multiple downlink component carriers and one or more uplink component carriers according to a carrier aggregation configuration. Carrier aggregation may be used with both frequency division duplexing (FDD) and time division duplexing (TDD) component carriers.

In some examples (e.g., in a carrier aggregation configuration), a carrier may also have acquisition signaling or control signaling that coordinates operations for other carriers. A carrier may be associated with a frequency channel (e.g., an evolved universal mobile telecommunication system terrestrial radio access (E-UTRA) absolute radio frequency channel number (EARFCN)) and may be positioned according to a channel raster for discovery by the UEs 115. A carrier may be operated in a standalone mode where initial acquisition and connection may be conducted by the UEs 115 via the carrier, or the carrier may be operated in a non-standalone mode where a connection is anchored using a different carrier (e.g., of the same or a different radio access technology).

The communication links 125 shown in the wireless communications system 100 may include uplink transmissions from a UE 115 to a base station 105, or downlink transmissions from a base station 105 to a UE 115. Carriers may carry downlink or uplink communications (e.g., in an FDD mode) or may be configured to carry downlink and uplink communications (e.g., in a TDD mode).

A carrier may be associated with a particular bandwidth of the radio frequency spectrum, and in some examples the carrier bandwidth may be referred to as a “system bandwidth” of the carrier or the wireless communications system 100. For example, the carrier bandwidth may be one of a number of determined bandwidths for carriers of a particular radio access technology (e.g., 1.4, 3, 5, 10, 15, 20, 40, or 80 megahertz (MHz)). Devices of the wireless communications system 100 (e.g., the base stations 105, the UEs 115, or both) may have hardware configurations that support communications over a particular carrier bandwidth or may be configurable to support communications over one of a set of carrier bandwidths. In some examples, the wireless communications system 100 may include base stations 105 or UEs 115 that support simultaneous communications via carriers associated with multiple carrier bandwidths. In some examples, each served UE 115 may be configured for operating over portions (e.g., a sub-band, a BWP) or all of a carrier bandwidth.

Signal waveforms transmitted over a carrier may be made up of multiple subcarriers (e.g., using multi-carrier modulation (MCM) techniques such as orthogonal frequency division multiplexing (OFDM) or discrete Fourier transform spread OFDM (DFT-S-OFDM)). In a system employing MCM techniques, a resource element may consist of one symbol period (e.g., a duration of one modulation symbol) and one subcarrier, where the symbol period and subcarrier spacing are inversely related. The number of bits carried by each resource element may depend on the modulation scheme (e.g., the order of the modulation scheme, the coding rate of the modulation scheme, or both). Thus, the more resource elements that a UE 115 receives and the higher the order of the modulation scheme, the higher the data rate may be for the UE 115. A wireless communications resource may refer to a combination of a radio frequency spectrum resource, a time resource, and a spatial resource (e.g., spatial layers or beams), and the use of multiple spatial layers may further increase the data rate or data integrity for communications with a UE 115.

One or more numerologies for a carrier may be supported, where a numerology may include a subcarrier spacing (Δf) and a cyclic prefix. A carrier may be divided into one or more BWPs having the same or different numerologies. In some examples, a UE 115 may be configured with multiple BWPs. In some examples, a single BWP for a carrier may be active at a given time and communications for the UE 115 may be restricted to one or more active BWPs.

The time intervals for the base stations 105 or the UEs 115 may be expressed in multiples of a basic time unit which may, for example, refer to a sampling period of Tₛ=1/(Δfₘₐₓ·N_{f}) seconds, where Δfₘₐₓ may represent the maximum supported subcarrier spacing, and N_{f} may represent the maximum supported discrete Fourier transform (DFT) size. Time intervals of a communications resource may be organized according to radio frames each having a specified duration (e.g., 10 milliseconds (ms)). Each radio frame may be identified by a system frame number (SFN) (e.g., ranging from 0 to 1023).

Each frame may include multiple consecutively numbered subframes or slots, and each subframe or slot may have the same duration. In some examples, a frame may be divided (e.g., in the time domain) into subframes, and each subframe may be further divided into a number of slots. Alternatively, each frame may include a variable number of slots, and the number of slots may depend on subcarrier spacing. Each slot may include a number of symbol periods (e.g., depending on the length of the cyclic prefix prepended to each symbol period). In some wireless communications systems 100, a slot may further be divided into multiple mini-slots containing one or more symbols. Excluding the cyclic prefix, each symbol period may contain one or more (e.g., N_{f}) sampling periods. The duration of a symbol period may depend on the subcarrier spacing or frequency band of operation.

A subframe, a slot, a mini-slot, or a symbol may be the smallest scheduling unit (e.g., in the time domain) of the wireless communications system 100 and may be referred to as a transmission time interval (TTI). In some examples, the TTI duration (e.g., the number of symbol periods in a TTI) may be variable. Additionally or alternatively, the smallest scheduling unit of the wireless communications system 100 may be dynamically selected (e.g., in bursts of shortened TTIs (sTTIs)).

Physical channels may be multiplexed on a carrier according to various techniques. A physical control channel and a physical data channel may be multiplexed on a downlink carrier, for example, using one or more of time division multiplexing (TDM) techniques, frequency division multiplexing (FDM) techniques, or hybrid TDM-FDM techniques. A control region (e.g., a control resource set (CORESET)) for a physical control channel may be defined by a number of symbol periods and may extend across the system bandwidth or a subset of the system bandwidth of the carrier. One or more control regions (e.g., CORESETs) may be configured for a set of the UEs 115. For example, one or more of the UEs 115 may monitor or search control regions for control information according to one or more search space sets, and each search space set may include one or multiple control channel candidates in one or more aggregation levels arranged in a cascaded manner. An aggregation level for a control channel candidate may refer to a number of control channel resources (e.g., control channel elements (CCEs)) associated with encoded information for a control information format having a given payload size. Search space sets may include common search space sets configured for sending control information to multiple UEs 115 and UE-specific search space sets for sending control information to a specific UE 115.

Each base station 105 may provide communication coverage via one or more cells, for example a macro cell, a small cell, a hot spot, or other types of cells, or any combination thereof. The term “cell” may refer to a logical communication entity used for communication with a base station 105 (e.g., over a carrier) and may be associated with an identifier for distinguishing neighboring cells (e.g., a physical cell identifier (PCID), a virtual cell identifier (VCID), or others). In some examples, a cell may also refer to a geographic coverage area 110 or a portion of a geographic coverage area 110 (e.g., a sector) over which the logical communication entity operates. Such cells may range from smaller areas (e.g., a structure, a subset of structure) to larger areas depending on various factors such as the capabilities of the base station 105. For example, a cell may be or include a building, a subset of a building, or exterior spaces between or overlapping with geographic coverage areas 110, among other examples.

A macro cell generally covers a relatively large geographic area (e.g., several kilometers in radius) and may allow unrestricted access by the UEs 115 with service subscriptions with the network provider supporting the macro cell. A small cell may be associated with a lower-powered base station 105, as compared with a macro cell, and a small cell may operate in the same or different (e.g., licensed, unlicensed) frequency bands as macro cells. Small cells may provide unrestricted access to the UEs 115 with service subscriptions with the network provider or may provide restricted access to the UEs 115 having an association with the small cell (e.g., the UEs 115 in a closed subscriber group (CSG), the UEs 115 associated with users in a home or office). A base station 105 may support one or multiple cells and may also support communications over the one or more cells using one or multiple component carriers.

In some examples, a carrier may support multiple cells, and different cells may be configured according to different protocol types (e.g., MTC, narrowband IoT (NB-IoT), enhanced mobile broadband (eMBB)) that may provide access for different types of devices.

In some examples, a base station 105 may be movable and therefore provide communication coverage for a moving geographic coverage area 110. In some examples, different geographic coverage areas 110 associated with different technologies may overlap, but the different geographic coverage areas 110 may be supported by the same base station 105. In other examples, the overlapping geographic coverage areas 110 associated with different technologies may be supported by different base stations 105. The wireless communications system 100 may include, for example, a heterogeneous network in which different types of the base stations 105 provide coverage for various geographic coverage areas 110 using the same or different radio access technologies.

The wireless communications system 100 may support synchronous or asynchronous operation. For synchronous operation, the base stations 105 may have similar frame timings, and transmissions from different base stations 105 may be approximately aligned in time. For asynchronous operation, the base stations 105 may have different frame timings, and transmissions from different base stations 105 may, in some examples, not be aligned in time. The techniques described herein may be used for either synchronous or asynchronous operations.

Some UEs 115, such as MTC or IoT devices, may be low cost or low complexity devices and may provide for automated communication between machines (e.g., via Machine-to-Machine (M2M) communication). M2M communication or MTC may refer to data communication technologies that allow devices to communicate with one another or a base station 105 without human intervention. In some examples, M2M communication or MTC may include communications from devices that integrate sensors or meters to measure or capture information and relay such information to a central server or application program that makes use of the information or presents the information to humans interacting with the application program. Some UEs 115 may be designed to collect information or enable automated behavior of machines or other devices. Examples of applications for MTC devices include smart metering, inventory monitoring, water level monitoring, equipment monitoring, healthcare monitoring, wildlife monitoring, weather and geological event monitoring, fleet management and tracking, remote security sensing, physical access control, and transaction-based business charging.

Some UEs 115 may be configured to employ operating modes that reduce power consumption, such as half-duplex communications (e.g., a mode that supports one-way communication via transmission or reception, but not transmission and reception simultaneously). In some examples, half-duplex communications may be performed at a reduced peak rate. Other power conservation techniques for the UEs 115 include entering a power saving deep sleep mode when not engaging in active communications, operating over a limited bandwidth (e.g., according to narrowband communications), or a combination of these techniques. For example, some UEs 115 may be configured for operation using a narrowband protocol type that is associated with a defined portion or range (e.g., set of subcarriers or resource blocks (RBs)) within a carrier, within a guard-band of a carrier, or outside of a carrier.

The wireless communications system 100 may be configured to support ultra-reliable communications or low-latency communications, or various combinations thereof. For example, the wireless communications system 100 may be configured to support ultra-reliable low-latency communications (URLLC) or mission critical communications. The UEs 115 may be designed to support ultra-reliable, low-latency, or critical functions (e.g., mission critical functions). Ultra-reliable communications may include private communication or group communication and may be supported by one or more mission critical services such as mission critical push-to-talk (MCPTT), mission critical video (MCVideo), or mission critical data (MCData). Support for mission critical functions may include prioritization of services, and mission critical services may be used for public safety or general commercial applications. The terms ultra-reliable, low-latency, mission critical, and ultra-reliable low-latency may be used interchangeably herein.

In some examples, a UE 115 may also be able to communicate directly with other UEs 115 over a device-to-device (D2D) communication link 135 (e.g., using a peer-to-peer (P2P) or D2D protocol). One or more UEs 115 utilizing D2D communications may be within the geographic coverage area 110 of a base station 105. Other UEs 115 in such a group may be outside the geographic coverage area 110 of a base station 105 or be otherwise unable to receive transmissions from a base station 105. In some examples, groups of the UEs 115 communicating via D2D communications may utilize a one-to-many (1:M) system in which each UE 115 transmits to every other UE 115 in the group. In some examples, a base station 105 facilitates the scheduling of resources for D2D communications. In other cases, D2D communications are carried out between the UEs 115 without the involvement of a base station 105.

In some systems, the D2D communication link 135 may be an example of a communication channel, such as a sidelink communication channel, between vehicles (e.g., UEs 115). In some examples, vehicles may communicate using vehicle-to-everything (V2X) communications, vehicle-to-vehicle (V2V) communications, or some combination of these. A vehicle may signal information related to traffic conditions, signal scheduling, weather, safety, emergencies, or any other information relevant to a V2X system. In some examples, vehicles in a V2X system may communicate with roadside infrastructure, such as roadside units, or with the network via one or more network nodes (e.g., base stations 105) using vehicle-to-network (V2N) communications, or with both.

The core network 130 may provide user authentication, access authorization, tracking, Internet Protocol (IP) connectivity, and other access, routing, or mobility functions. The core network 130 may be an evolved packet core (EPC) or 5G core (5GC), which may include at least one control plane entity that manages access and mobility (e.g., a mobility management entity (MME), an access and mobility management function (AMF)) and at least one user plane entity that routes packets or interconnects to external networks (e.g., a serving gateway (S-GW), a Packet Data Network (PDN) gateway (P-GW), or a user plane function (UPF)). The control plane entity may manage non-access stratum (NAS) functions such as mobility, authentication, and bearer management for the UEs 115 served by the base stations 105 associated with the core network 130. User IP packets may be transferred through the user plane entity, which may provide IP address allocation as well as other functions. The user plane entity may be connected to the network operators IP services 150. The operators IP services 150 may include access to the Internet, Intranet(s), an IP Multimedia Subsystem (IMS), or a Packet-Switched Streaming Service.

Some of the network devices, such as a base station 105, may include subcomponents such as an access network entity 140, which may be an example of an access node controller (ANC). Each access network entity 140 may communicate with the UEs 115 through one or more other access network transmission entities 145, which may be referred to as radio heads, smart radio heads, or transmission/reception points (TRPs). Each access network transmission entity 145 may include one or more antenna panels. In some configurations, various functions of each access network entity 140 or base station 105 may be distributed across various network devices (e.g., radio heads and ANCs) or consolidated into a single network device (e.g., a base station 105).

The wireless communications system 100 may operate using one or more frequency bands, typically in the range of 300 megahertz (MHz) to 300 gigahertz (GHz). Generally, the region from 300 MHz to 3 GHz is known as the ultra-high frequency (UHF) region or decimeter band because the wavelengths range from approximately one decimeter to one meter in length. The UHF waves may be blocked or redirected by buildings and environmental features, but the waves may penetrate structures sufficiently for a macro cell to provide service to the UEs 115 located indoors. The transmission of UHF waves may be associated with smaller antennas and shorter ranges (e.g., less than 100 kilometers) compared to transmission using the smaller frequencies and longer waves of the high frequency (HF) or very high frequency (VHF) portion of the spectrum below 300 MHz.

The wireless communications system 100 may also operate in a super high frequency (SHF) region using frequency bands from 3 GHz to 30 GHz, also known as the centimeter band, or in an extremely high frequency (EHF) region of the spectrum (e.g., from 30 GHz to 300 GHz), also known as the millimeter band. In some examples, the wireless communications system 100 may support millimeter wave (mmW) communications between the UEs 115 and the base stations 105, and EHF antennas of the respective devices may be smaller and more closely spaced than UHF antennas. In some examples, this may facilitate use of antenna arrays within a device. The propagation of EHF transmissions, however, may be subject to even greater atmospheric attenuation and shorter range than SHF or UHF transmissions. The techniques disclosed herein may be employed across transmissions that use one or more different frequency regions, and designated use of bands across these frequency regions may differ by country or regulating body.

The wireless communications system 100 may utilize both licensed and unlicensed radio frequency spectrum bands. For example, the wireless communications system 100 may employ License Assisted Access (LAA), LTE-Unlicensed (LTE-U) radio access technology, or NR technology in an unlicensed band such as the 5 GHz industrial, scientific, and medical (ISM) band. When operating in unlicensed radio frequency spectrum bands, devices such as the base stations 105 and the UEs 115 may employ carrier sensing for collision detection and avoidance. In some examples, operations in unlicensed bands may be based on a carrier aggregation configuration in conjunction with component carriers operating in a licensed band (e.g., LAA). Operations in unlicensed spectrum may include downlink transmissions, uplink transmissions, P2P transmissions, or D2D transmissions, among other examples.

A base station 105 or a UE 115 may be equipped with multiple antennas, which may be used to employ techniques such as transmit diversity, receive diversity, multiple-input multiple-output (MIMO) communications, or beamforming. The antennas of a base station 105 or a UE 115 may be located within one or more antenna arrays or antenna panels, which may support MIMO operations or transmit or receive beamforming. For example, one or more base station antennas or antenna arrays may be co-located at an antenna assembly, such as an antenna tower. In some examples, antennas or antenna arrays associated with a base station 105 may be located in diverse geographic locations. A base station 105 may have an antenna array with a number of rows and columns of antenna ports that the base station 105 may use to support beamforming of communications with a UE 115. Likewise, a UE 115 may have one or more antenna arrays that may support various MIMO or beamforming operations. Additionally or alternatively, an antenna panel may support radio frequency beamforming for a signal transmitted via an antenna port.

The base stations 105 or the UEs 115 may use MIMO communications to exploit multipath signal propagation and increase the spectral efficiency by transmitting or receiving multiple signals via different spatial layers. Such techniques may be referred to as spatial multiplexing. The multiple signals may, for example, be transmitted by the transmitting device via different antennas or different combinations of antennas. Likewise, the multiple signals may be received by the receiving device via different antennas or different combinations of antennas. Each of the multiple signals may be referred to as a separate spatial stream and may carry bits associated with the same data stream (e.g., the same codeword) or different data streams (e.g., different codewords). Different spatial layers may be associated with different antenna ports used for channel measurement and reporting. MIMO techniques include single-user MIMO (SU-MIMO), where multiple spatial layers are transmitted to the same receiving device, and multiple-user MIMO (MU-MIMO), where multiple spatial layers are transmitted to multiple devices.

Beamforming, which may also be referred to as spatial filtering, directional transmission, or directional reception, is a signal processing technique that may be used at a transmitting device or a receiving device (e.g., a base station 105, a UE 115) to shape or steer an antenna beam (e.g., a transmit beam, a receive beam) along a spatial path between the transmitting device and the receiving device. Beamforming may be achieved by combining the signals communicated via antenna elements of an antenna array such that some signals propagating at particular orientations with respect to an antenna array experience constructive interference while others experience destructive interference. The adjustment of signals communicated via the antenna elements may include a transmitting device or a receiving device applying amplitude offsets, phase offsets, or both to signals carried via the antenna elements associated with the device. The adjustments associated with each of the antenna elements may be defined by a beamforming weight set associated with a particular orientation (e.g., with respect to the antenna array of the transmitting device or receiving device, or with respect to some other orientation).

A base station 105 or a UE 115 may use beam sweeping techniques as part of beam forming operations. For example, a base station 105 may use multiple antennas or antenna arrays (e.g., antenna panels) to conduct beamforming operations for directional communications with a UE 115. Some signals (e.g., synchronization signals, reference signals, beam selection signals, or other control signals) may be transmitted by a base station 105 multiple times in different directions. For example, the base station 105 may transmit a signal according to different beamforming weight sets associated with different directions of transmission. Transmissions in different beam directions may be used to identify (e.g., by a transmitting device, such as a base station 105, or by a receiving device, such as a UE 115) a beam direction for later transmission or reception by the base station 105.

Some signals, such as data signals associated with a particular receiving device, may be transmitted by a base station 105 in a single beam direction (e.g., a direction associated with the receiving device, such as a UE 115). In some examples, the beam direction associated with transmissions along a single beam direction may be determined based on a signal that was transmitted in one or more beam directions. For example, a UE 115 may receive one or more of the signals transmitted by the base station 105 in different directions and may report to the base station 105 an indication of the signal that the UE 115 received with a highest signal quality or an otherwise acceptable signal quality.

In some examples, transmissions by a device (e.g., by a base station 105 or a UE 115) may be performed using multiple beam directions, and the device may use a combination of digital precoding or radio frequency beamforming to generate a combined beam for transmission (e.g., from a base station 105 to a UE 115). The UE 115 may report feedback that indicates precoding weights for one or more beam directions, and the feedback may correspond to a configured number of beams across a system bandwidth or one or more sub-bands. The base station 105 may transmit a reference signal (e.g., a cell-specific reference signal (CRS), a channel state information (CSI) reference signal (CSI-RS)), which may be precoded or unprecoded. The UE 115 may provide feedback for beam selection, which may be a precoding matrix indicator (PMI) or codebook-based feedback (e.g., a multi-panel type codebook, a linear combination type codebook, a port selection type codebook). Although these techniques are described with reference to signals transmitted in one or more directions by a base station 105, a UE 115 may employ similar techniques for transmitting signals multiple times in different directions (e.g., for identifying a beam direction for subsequent transmission or reception by the UE 115) or for transmitting a signal in a single direction (e.g., for transmitting data to a receiving device).

A receiving device (e.g., a UE 115) may try multiple receive configurations (e.g., directional listening) when receiving various signals from the base station 105, such as synchronization signals, reference signals, beam selection signals, or other control signals. For example, a receiving device may try multiple receive directions by receiving via different antenna subarrays, by processing received signals according to different antenna subarrays, by receiving according to different receive beamforming weight sets (e.g., different directional listening weight sets) applied to signals received at multiple antenna elements of an antenna array, or by processing received signals according to different receive beamforming weight sets applied to signals received at multiple antenna elements of an antenna array, any of which may be referred to as “listening” according to different receive configurations or receive directions. In some examples, a receiving device may use a single receive configuration to receive along a single beam direction (e.g., when receiving a data signal). The single receive configuration may be aligned in a beam direction determined based on listening according to different receive configuration directions (e.g., a beam direction determined to have a highest signal strength, highest signal-to-noise ratio (SNR), or otherwise acceptable signal quality based on listening according to multiple beam directions).

The wireless communications system 100 may be a packet-based network that operates according to a layered protocol stack. In the user plane, communications at the bearer or Packet Data Convergence Protocol (PDCP) layer may be IP-based. A Radio Link Control (RLC) layer may perform packet segmentation and reassembly to communicate over logical channels. A Medium Access Control (MAC) layer may perform priority handling and multiplexing of logical channels into transport channels. The MAC layer may also use error detection techniques, error correction techniques, or both to support retransmissions at the MAC layer to improve link efficiency. In the control plane, the Radio Resource Control (RRC) protocol layer may provide establishment, configuration, and maintenance of an RRC connection between a UE 115 and a base station 105 or a core network 130 supporting radio bearers for user plane data. At the physical layer, transport channels may be mapped to physical channels.

The UEs 115 and the base stations 105 may support retransmissions of data to increase the likelihood that data is received successfully. Hybrid automatic repeat request (HARQ) feedback is one technique for increasing the likelihood that data is received correctly over a communication link 125. HARQ may include a combination of error detection (e.g., using a cyclic redundancy check (CRC)), forward error correction (FEC), and retransmission (e.g., automatic repeat request (ARQ)). HARQ may improve throughput at the MAC layer in poor radio conditions (e.g., low signal-to-noise conditions). In some examples, a device may support same-slot HARQ feedback, where the device may provide HARQ feedback in a specific slot for data received in a previous symbol in the slot. In other cases, the device may provide HARQ feedback in a subsequent slot, or according to some other time interval.

In some examples, UE 115 may receive, from a base station 105, a resource configuration for sidelink communications. The resource configuration may allow UE 115 to schedule sidelink resources or the base station 105 may schedule the sidelink resources. The UE 115 may transmit, to a receiving UE 115, SCI via one or more SCI messages, the SCI including one or more SPS indications pertaining to an SPS configuration for communications from the transmitting UE 115 to the receiving UE 115. For example, the transmitting UE 115 may include in the SPS indications one or more of an activation or deactivation indicator in either the first SCI message or the second SCI message, a configuration index in the second SCI message, and an SPS identifier in the first SCI message. UE 115 may then monitor for feedback information from the receiving UE 115 pertaining to the SCI prior to proceeding with SPS sidelink transmissions in accordance with the one or more SPS indications. For example, a feedback message may indicate that the SPS configuration is active based on the SCI including the one or more SPS indications.

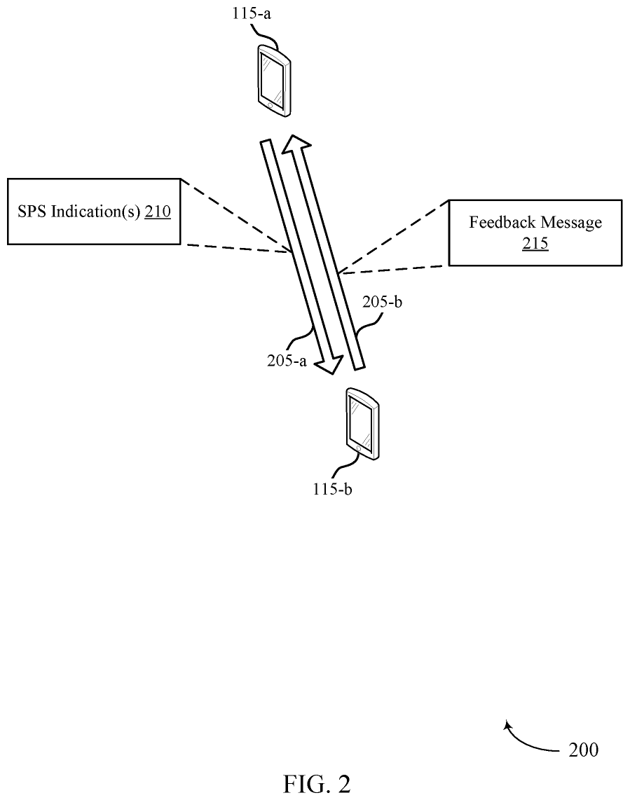

FIG. 2 illustrates an example of a wireless communications system 200 that supports SPS of sidelink communications in accordance with aspects of the present disclosure. In some examples, wireless communications system 200 may implement aspects of wireless communications system 100. Wireless communications system 200 may include UEs 115-a and 115-b, which may be examples of UE 115 with respect to FIG. 1. UEs 115-a and 115-b may support SPS of sidelink communications.

UEs 115-a and 115-b may communicate via sidelinks 205. For example, UE 115-a may transmit communications to UE 115-b on sidelink 205-a, and UE 115-b may transmit communications to UE 115-a on sidelink 205-b. In some examples, this wireless communications system 200 may be an industrial IoT system, where UE 115-a may be a controller and UE 115-b may be a sensor or actuator.

The mission-critical traffic between UEs 115-a and 115-b may be deterministic and periodic according to cyclic exchanges between a controller and a number of sensors and actuators. Although a single receiving UE 115-b is shown, multiple sensors and actuators (e.g., about 20 to 50 sensors/actuators per controller) may be in communication with UE 115-a in a system. Additionally, many controllers may be present in a system, for example about 100 to 1000 controllers in a factory. The data transmitted between UEs 115-a and 115-b may relatively small, for example an application-layer payload may be about 40 to 256 bytes, however, in traditional sidelink design various headers may consume a large amount of overhead signaling. In some cases, this overhead signaling may make it difficult for a system to meet the stringent latency and reliability requirements of an industrial IoT system, for example, latency requirements may be about 1 to 2 ms of allowed delays, and reliability requirements may entail an error rate of about 10^−6 or less.

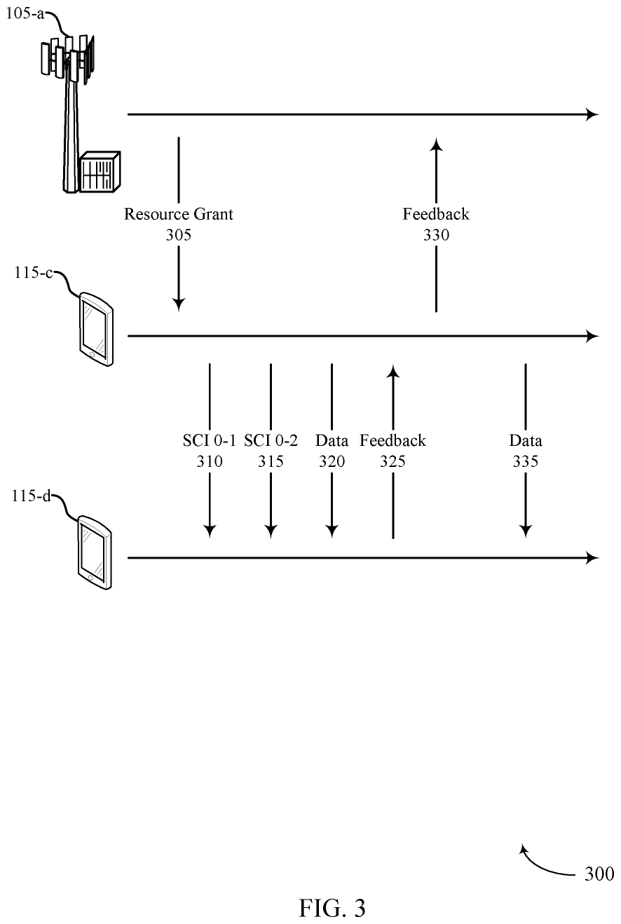

Factories may be transitioning away from wireline communications to wireless communications to reduce reconfiguration cost on a factory floor. In some cases, controllers may be located close to machinery where sensors and actuators are located, and base stations may be ceiling-mounted if present. Each controller (e.g., UE 115-a) may wirelessly communicate with a base station through the Uu interface and may wirelessly communicate with sensors and actuators (e.g., UE 115-b) through the PC5 sidelink interface (e.g., sidelinks 205). Some systems may include a base station and operate in sidelink mode 1, where the base station schedules the sidelink resources on sidelinks 205. Mode 1 is described in further detail with respect to FIG. 3. Other systems may or may not include a base station and operate in sidelink mode 2, where a UE 115 (e.g., UE 115-a) schedules the sidelink resources on sidelinks 205. Mode 2 is described in further detail with respect to FIG. 3.

Current PC5 design supports configured grants (e.g., CG1 and CG2) where the periodic resources are granted by a base station for a transmitting UE 115 to use periodically. However, the transmitting UE 115-a may also periodically send SCI 0-1 and SCI 0-2 even when they remain the same in a periodic manner. In other words, current PC5 design does not support SPS, which may lead to reduced system reliability through the large amount of signaling overhead. For example, due to the deterministic and periodic traffic in industrial IoT, a controller that has been granted resources from a base station may want to schedule SPS for a PC5 connection (e.g., sidelinks 205) between itself (e.g., UE 115-a) and a sensor or actuator (e.g., UE 115-b) to reduce control signaling overhead and thus improve reliability of the system. According to the techniques described herein, a UE 115-a which has been granted resources by a base station (e.g., in Mode 1 or 2) may send SPS indication(s) 210 to UE 115-b through one or more SCI messages. For example, the UE 115-a may transmit SPS indications 210 to the UE 115-b through an SCI 0-1 message, an SCI 0-2 message, or both, along with the first PSSCH data. After activation of the SPS configuration, UE 115-a may skip transmission of both SCI 0-1 and SCI 0-2 for future PSSCH, which may be useful in Mode 1. Alternatively, UE 115-a may skip SCI 0-2 and transmit SCI 0-1, which may be useful in Mode 2 to maintain existing resource sensing procedures.

In some examples, the SPS indication(s) 210 may include one or more indicators. For a given combination of SCI 0-1 and SCI 0-2 that can be used for scheduling (e.g., a dynamic scheduling), UE 115-a, which has been granted resources by a base station, may transmit an SPS activation/deactivation to UE 115-b by using one or more of an SPS indicator conveyed via SCI 0-1, an SPS activation/deactivation indicator inside SCI 0-1 or SCI 0-2, and an SPS configuration index inside SCI 0-2

The SPS indicator conveyed via SCI 0-1 may be conveyed in a number of ways. For example, the SPS indicator may be conveyed via SCI 0-1 by using a common sidelink-SPS-radio network temporary identifier (SL-SPS-RNTI) to scramble the cyclic redundancy check (CRC) of SCI 0-1. If the CRC is scrambled with a SL-SPS-RNTI, then a decoding UE 115-b may understand that this SCI 0-1 message and the subsequent SCI 0-2 contains SPS information. If the CRC is unscrambled, then UE 115-b may perform conventional non-SPS PC5 operations and decodes the corresponding SCI 0-2. In another example, the SPS indicator may be conveyed via SCI 0-1 by using one or several fields inside SCI 0-1 to indicate the presence of SPS information in SCI 0-2. For example, if all of the bits in an SCI 0-2 format field inside an SCI 0-1 are set to 1, this may indicate that the SCI 0-1 and SCI 0-2 contain SPS information. In other examples, an extra dedicated SPS field may be included inside SCI 0-1 to indicate the presence of SPS information in this SCI 0-1 and SCI 0-2.

The SPS activation/deactivation indicator may be conveyed in a number of ways inside SCI 0-1 or SCI 0-2. For example, the SPS activation/deactivation indicator may be conveyed by using one or several fields (e.g., time/frequency resource assignment fields) inside an SCI 0-1 message or an SCI 0-2 message to indicate SPS configuration activation/deactivation. In some cases, the SPS indicator conveyed via SCI 0-1 is turned on to indicate SPS information is present in the SCI, and if the new data indicator bit inside SCI 0-2 equals 0 and the frequency and time resource assignments are valid, this indicates SPS activation. On the other hand, if the new data indicator bit inside SCI 0-2 equals 0 but the frequency and time resource assignments are set to all zeros (e.g., all “0”s) or all ones (e.g., all “1”s), this indicates SPS deactivation. In other examples, an extra dedicated SPS field may be included inside SCI 0-1 or SCI 0-2 to indicate SPS configuration activation or deactivation. In additional or alternative implementations, setting the redundancy version field within control signaling (e.g., SCI signaling) to all zeros (e.g., all “0”s) may be used to indicate SPS activation, SPS release, or both.

The SPS configuration index may be conveyed in a number of ways inside SCI 0-1 or SCI 0-2. For example, the SPS configuration index may be conveyed in one or several fields inside SCI 0-1 and/or SCI 0-2 to indicate the configuration index. In some cases, the SPS indicator conveyed via SCI 0-1 is turned on, and some bits inside the HARQ process ID field inside SCI 0-2 may be used to specify the configuration index. In another example, the SPS indicator conveyed via SCI 0-1 is turned on, and an extra dedicated SPS configuration index field may be included inside SCI 0-1 or SCI 0-2 to indicate which SPS configuration the SPS information in the SCI pertains to.

In some examples, parameters could be pre-configured and agreed upon between UE 115-a and UE 115-b for each sidelink SPS configuration. These parameters may include a configuration index for identifying the SPS configuration; an SL-SPS-RNTI for activation, deactivation, and retransmission; periodicity of SPS; and the maximum number of times that a transport block may be transmitted using the configured grant. These parameters may be pre-configured by UE 115-a or alternatively by a base station.

UE 115-b may respond to the SPS indication(s) 210 with feedback message 215. The SPS configuration of SPS indication(s) 210 is considered complete when UE 115-a receives the feedback message 215 on a physical sidelink feedback channel (PSFCH) from UE 115-b. The subsequent PSSCH from UE 115-a may not be accompanied by SCI 0-1 and SCI 0-2. The SPS configuration activation may be considered incomplete if UE 115-a has not received any feedback on a PSFCH from UE 115-b. When the activation is incomplete, every PSSCH transmitted according to the SPS configuration is preceded by the SCI 0-1 and SCI 0-2.

Once an SPS configuration is active between UEs 115-a and 115-b, multiple retransmission strategies may be configured for when UE 115-b transmits and UE 115-a receives a NACK on a PSFCH via sidelink 205-b. One retransmission strategy may include SPS retransmission where a retransmission occurs on the next PSSCH provided by the same SPS configuration that schedules the PSFCH. The retransmission may be indicated by using one or several fields inside SCI 0-1 or SCI 0-2. For example, UE 115-a may turn on the SPS indicator and set the new data indicator in SCI 0-2 to 1 to indicate that the subsequent PSSCH is a retransmission. Another retransmission strategy may include dynamic retransmission where UE 115-a requests retransmission resources from a base station through a physical uplink control channel (PUCCH) and allocates the resources for retransmission with the same HARQ ID as if the retransmission consists of new data. For example, UE 115-a may send SCI 0-1 and SCI 0-2 followed by a retransmission on PSSCH with new data indicator field set to 1 and HARQ ID field set to the HARQ ID of the SPS.

FIG. 3 illustrates an example of a sidelink mode 300 that supports SPS of sidelink communications in accordance with aspects of the present disclosure. In some examples, sidelink mode 300 may implement aspects of wireless communications system 100. Sidelink mode 300 may include UEs 115-c and 115-d, which may be examples of UEs 115-a and 115-b, respectively with respect to FIG. 2. Sidelink mode 300 may also include base station 105-a, which may be an example of base station 105 with respect to FIG. 1. In some cases, sidelink mode 300 may be referred to as sidelink mode 1 and may support SPS of sidelink communications.

In sidelink mode 1, base station 105-a may schedule sidelink resources to be used by UEs 115-c and 115-d for sidelink transmissions. In mode 1, dynamic grants (DG), configured grants (CG) type 1, and CG type 2 are supported. CG type 1 may be activated via RRC signaling on the Uu interface from base station 105-a. DG and CG type 2 may be conveyed using downlink control information (DCI) (e.g., DCI 3_0) over a physical downlink control channel (PDCCH) on the Uu interface from base station 105-a. In some cases, the DCI may be a DG that provides a resource allocation to use over sidelink. The DCI may activate/deactivate a CG type 2 for sidelink, and UE 115-c may report activation/deactivation confirmation using a MAC-CE transmitted to base station 105-a. UE 115-c may report a sidelink buffer status report (B SR) to base station 105-a using MAC-CE. UE 115-c may select the modulation and coding scheme (MCS) within limits set by base station 105-a.

The DCI format may be used to schedule PSCCH and PSSCH in one cell. The DCI CRC may be scrambled by SL-RNTI or SL-CS-RNTI. The DCI may include a time gap, a HARQ process ID, a new data indicator, a lowest index of the subchannel allocation to the initial transmission, 1st-stage SCI Format 0-1 fields frequency resource assignment field(s) and time resource assignment field(s), a PSFCH-to-HARQ feedback timing indicator, a PUCCH resource indicator, and a configuration index (e.g., for CG).

As described herein, base station 105-a may transmit a resource grant 305 (e.g., via an RRC message or DCI on PDCCH) to UE 115-c. UE 115-c may confirm the activation through MAC-CE (not shown). UE 115-c may transmit to UE 115-d SCI 0-1 310 and SCI 0-2 315 on PSCCH to schedule PSSCH and transmit data 320 on a PSSCH. UE 115-d may send feedback 325 (e.g., ACK/NACK) on PSFCH upon receiving each transmission, SCI 0-1 310, SCI 0-2 315, and data 320. UE 115-c may forward the feedback 330 to base station 105-a on a PUCCH. In some examples, SCI 0-1 310 and SCI 0-2 315 may include SPS information.

The SCI 0-1 310 may be used to schedule PSSCH (e.g., data 320). The SCI 0-1 310 may include priority information, a frequency resource assignment (e.g., frequency resource assignment field(s)), a time resource assignment (e.g., time resource assignment field(s)), a resource reservation period, a demodulation reference signal (DMRS) pattern, a 2nd-stage SCI Format (e.g., broadcast, unicast, groupcast), a beta offset indicator, a number of DMRS port, a MCS, and a number of reserved bits. The SCI 0-2 315 may also be used to schedule PSSCH (e.g., data 320). The SCI 0-2 315 may be transmitted after SCI 0-1 310 and may include a HARQ Process ID, a new data indicator, a redundancy version, a source ID, a destination ID, a CSI request, or any combination thereof. Additionally, if the SCI 0-2 315 format field in the corresponding SCI format 0-1 310 indicates type 1 groupcast, then the following fields are present a zone ID field and a communication range requirement field.

When UE 115-c wants to use SPS for sidelink communications with UE 115-d, UE 115-c may receive one or multiple configured resource grants 305 from base station 105-a. The activation of an SPS configuration, which resources are provided by all the received CGs in 305, are performed as follows. First, UE 115-c may transmit SCI 0-1 310 and then SCI 0-2 315 followed by PSSCH data 320. Then, the two SCIs (e.g., SCI 0-1 310 and SCI 0-2 315) together may carry the SPS information such as the SPS indicator, the SPS activation/deactivation indicator, and the SPS configuration index.

The SPS configuration activation is considered incomplete if UE 115-c has not received feedback 325 on PSFCH sent by UE 115-d. When the activation is incomplete, every PSSCH (e.g., data 335) may be transmitted according to the SPS may be preceded by the SCI 0-1 and SCI 0-2. The SPS configuration activation is considered complete if UE 115-c has received feedback 325 on PSFCH sent by UE 115-d. As shown, the subsequent PSSCH data 335 may not be accompanied by SCI 0-1 and SCI 0-2. Modification of SCI 0-1 and/or SCI 0-2 of an SPS configuration may be achieved by sending updated SCI 0-1 and updated SCI 0-2 with SPS information. For example, when UE 115-c wants to change MCS, it may send both SCIs with an updated MCS field as if activating the same SPS configuration. The deactivation of SPS is similar to activation except that the value for activation/deactivation indicator is toggled to different value.

UE 115-d may monitor for SCI 0-1 310 and the corresponding SCI 0-2 315. If SCI 0-1 310 contains SPS information as stated in the SPS indicator field, UE 115-d may carry out the following operations. First, UE 115-d may decode the corresponding SCI 0-2 315 and PSSCH data 320. Then, UE 115-d may transmit feedback 325 (e.g., an ACK/NACK on PSFCH). If the SPS information indicates an SPS activation, UE 115-d may store the SPS configuration and the two SCIs. Then, UE 115-d may receive data 335 from the PSSCH channel and send ACK/NACK on PSFCH periodically according to the stored SPS and SCIs. If the configuration index indicates that the SPS activation is new, UE 115-d may add the periodic SPS procedures to the existing ones. If the configuration index indicates that the SPS activation is indeed a modification of an existing SPS, UE 115-d may update the existing periodic SPS procedures, rather than creating a new one. If it is an SPS deactivation, UE 115-d may cancel the SPS configuration and stop the periodic monitoring of the PSSCH channel.

After an SPS configuration is activated, UE 115-c may determine if SCI should be transmitted with subsequent data 335. For example, if subsequent SCI 0-1 and SCI 0-2 contents are identical to the last acknowledged activation message (i.e., no further modification), then UE 115-c may skip both SCI 0-1 and SCI 0-2 when it periodically sends PSSCH data. If the SCI 0-1 and SCI 0-2 contents are modified, UE 115-c may repeat the activation procedure described above before it sends PSSCH data. Additionally, after the SPS configuration is activated by feedback 325, UE 115-d may continue to monitor every SCI 0-1 and the corresponding SCI 0-2. If no pair of SCI 0-1 and SCI 0-2 contain SPS information regarding to a stored configuration, the stored configuration and SCIs remains valid. Thus, UE 115-d may receive data 335 from the corresponding PSSCH periodically. If a pair of SCI 0-1 and SCI 0-2 contains SPS information regarding an existing stored configuration and the pair of SCIs does not indicate deactivation, then UE 115-d may update the stored configuration and receives data 335 from the corresponding PSSCH periodically. In some cases, retransmission od data may occur as described with respect to FIG. 2.

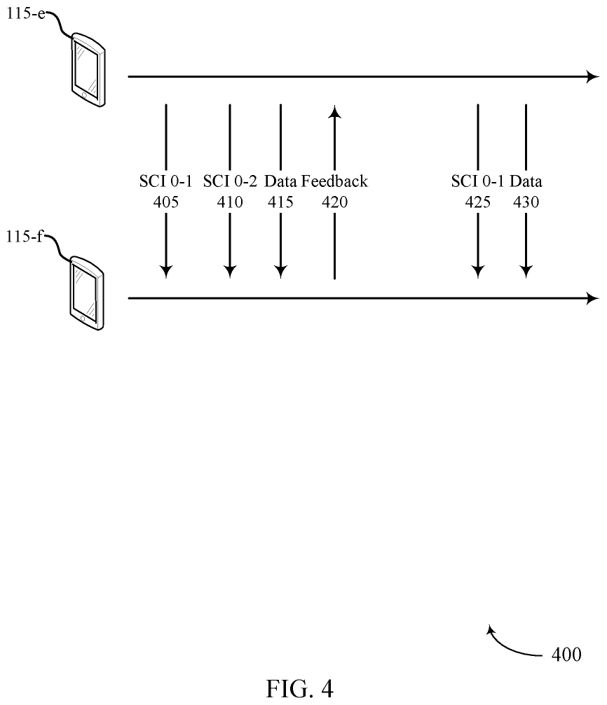

FIG. 4 illustrates an example of a sidelink mode 400 that supports SPS of sidelink communications in accordance with aspects of the present disclosure. In some examples, sidelink mode 400 may implement aspects of wireless communications system 100. Sidelink mode 400 may include UEs 115-e and 115-f, which may be examples of UEs 115-a and 115-b, respectively with respect to FIG. 2. In some cases, sidelink mode 400 may be referred to as sidelink mode 2 and may support SPS of sidelink communications.

In sidelink mode 2, UE 115-e may determine a base station does not schedule sidelink transmission resource(s) within sidelink resources configured by a base station or pre-configured sidelink resources. UE 115-e may sense and select resources based on measuring sidelink reference signal received power (RSRP) of sidelink DMRS, where the sidelink DMRS resides in PSSCH. If the sidelink is available, then UE 115-e may use SCI 0-1 405 and SCI 0-2 410 to schedule PSSCH and transmit data 415 through PSSCH. UE 115-f may transmit feedback 420 on PSFCH upon receiving each transmission.

The SCI 0-1 405 may be used to schedule PSSCH (e.g., data 415). The SCI 0-1 405 may include priority information, a frequency resource assignment (e.g., frequency resource assignment field(s)), a time resource assignment (e.g., time resource assignment field(s)), a resource reservation period, a DMRS pattern, a 2nd-stage SCI Format (e.g., broadcast, unicast, groupcast), a beta offset indicator, a number of DMRS port, a MCS, and a number of reserved bits. The SCI 0-2 410 may also be used to schedule PSSCH (e.g., data 415). The SCI 0-2 410 may be transmitted after SCI 0-1 405 and may include a HARQ Process ID, a new data indicator, a redundancy version, a source ID, a destination ID, a CSI request, or any combination thereof. Additionally, if the SCI 0-2 410 format field in the corresponding SCI format 0-1 405 indicates type 1 oupcast, then the following fields are present a zone ID field and a communication range requirement field.

When UE 115-e wants to use SPS for sidelink communications with UE 115-f, UE 115-e may receive one or multiple configured resource grants from a base station (not shown). The activation of an SPS configuration, which resources are provided by all the received CGs, are performed as follows. First, UE 115-e may transmit SCI 0-1 405 and then SCI 0-2 410 followed by PSSCH data 415. Then, the two SCIs (e.g., SCI 0-1 405 and SCI 0-2 410) together may carry the SPS information such as, the SPS indicator, the SPS activation/deactivation indicator, and the SPS configuration index.

The SPS configuration activation is considered incomplete if UE 115-e has not received feedback 420 on PSFCH sent by UE 115-f When the activation is incomplete, every PSSCH (e.g., data 430) may be transmitted according to the SPS may be preceded by the SCI 0-1 and SCI 0-2. The SPS configuration activation is considered complete if UE 115-e has received feedback 420 on PSFCH sent by UE 115-f As shown, the subsequent PSSCH data 430 may not be accompanied by SCI 0-2. Modification of SCI 0-1 and/or SCI 0-2 of an SPS configuration may be achieved by sending updated SCI 0-1 and updated SCI 0-2 with SPS information. For example, when UE 115-e wants to change MCS, it may send both SCIs with an updated MCS field as if activating the same SPS configuration. The deactivation of SPS is similar to activation except that the value for activation/deactivation indicator is toggled to different value.

UE 115-f may monitor for SCI 0-1 405 and the corresponding SCI 0-2 410. If SCI 0-1 405 contains SPS information as stated in the SPS indicator field, UE 115-f may carry out the following operations. First, UE 115-f may decode the corresponding SCI 0-2 410 and PSSCH data 415. Then, UE 115-f may transmit feedback 420 (e.g., an ACK/NACK on PSFCH). If the SPS information indicates an SPS activation, UE 115-f may store the SPS configuration and the two SCIs. Then, UE 115-f may receive data 430 from the PSSCH channel and send ACK/NACK on PSFCH periodically according to the stored SPS and SCIs. If the configuration index indicates that the SPS activation is new, UE 115-f may add the periodic SPS procedures to the existing ones. If the configuration index indicates that the SPS activation is indeed a modification of an existing SPS, UE 115-f may update the existing periodic SPS procedures, rather than creating a new one. If it is an SPS deactivation, UE 115-f may cancel the SPS configuration and stop the periodic monitoring of the PSSCH channel.

After an SPS configuration is activated, UE 115-e may determine if SCI should be transmitted with subsequent data 430. For example, if subsequent SCI 0-1 and SCI 0-2 contents are identical to the last acknowledged activation message (i.e. no further modification), then UE 115-e may skip SCI 0-2 when it periodically sends SCI 0-1 425 and PSSCH data 430. Unlike in mode 1, UE 115-e will transmit identical SCI 0-1 in mode 2 to maintain existing resource sensing procedures. If the SCI 0-1 and SCI 0-2 contents are modified, UE 115-e may repeat the activation procedure described above before it sends PSSCH data. Additionally, after the SPS configuration is activated by feedback 420, UE 115-f may continue to monitor every SCI 0-1 and the corresponding SCI 0-2. If no pair of SCI 0-1 and SCI 0-2 contain SPS information regarding to a stored configuration, the stored configuration and SCIs remains valid. Thus, UE 115-f may receive data 430 from the corresponding PSSCH periodically. If a pair of SCI 0-1 and SCI 0-2 contains SPS information regarding an existing stored configuration and the pair of SCIs does not indicate deactivation, then UE 115-f may update the stored configuration and receives data 430 from the corresponding PSSCH periodically. In some cases, retransmission od data may occur as described with respect to FIG. 2.

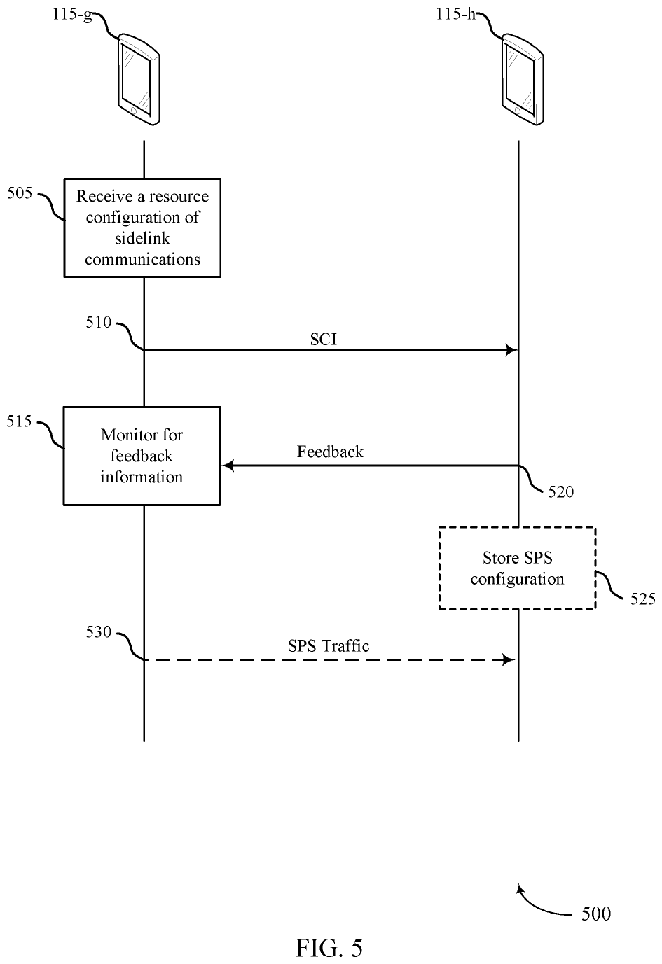

FIG. 5 illustrates an example of a process flow 500 that supports SPS of sidelink communications in accordance with aspects of the present disclosure. In some examples, process flow 500 may implement aspects of wireless communications system 100. Process flow 500 may include UEs 115-g and 115-h , which may be examples of a UE 115 as described herein with reference to FIGS. 1-4. For example, UE 115-g may be an example of UE 115-a as described with reference to FIG. 2, and UE 115-h may be an example of UE 115-b as described with reference to FIG. 2.

In the following description of the process flow 500, the operations between UE 115-g and UE 115-h may be performed in a different order than the order shown, or the operations performed by UE 115-g and UE 115-h may be performed in different orders or at different times. Some operations may also be left out of the process flow 500, or other operations may be added to the process flow 500. It is to be understood that while UE 115-g and UE 115-h are shown performing a number of the operations of process flow 500, any wireless device may perform the operations shown.

At 505, UE 115-g may receive, from a base station, a resource configuration for sidelink communications. The resource configuration may allow UE 115-g to schedule sidelink resources or the base station may schedule the sidelink resources.

At 510, UE 115-g may transmit and UE 115-h may receive SCI via a first SCI message and a second SCI message, the SCI comprising one or more SPS indications pertaining to an SPS configuration for communications from the transmitting UE to the receiving UE based on the resource configuration. For example, UE 115-g may include, as one of the one or more SPS indications, an activation or deactivation indicator in either the first SCI message or the second SCI message, where the activation or deactivation indicator is indicative of the SPS configuration being either activated or deactivated, respectively. Additionally or alternatively, UE 115-g may include, as one of the one or more SPS indications, a configuration index in the second SCI message, where the configuration index is indicative of the SPS configuration. Additionally or alternatively, UE 115-g may include, as one of the one or more SPS indications, an SPS identifier in the first SCI message, where the SPS identifier is indicative that the SCI includes the SPS configuration.

At 515, UE 115-g may monitor for feedback information pertaining to the SCI prior to proceeding with semi-persistent scheduled sidelink transmissions in accordance with the one or more SPS indications. For example, a feedback message may indicate that the SPS configuration is active based on the SCI including the one or more SPS indications. At 520, UE 115-h may transmit and UE 115-g may receive feedback information associated with the SCI.

At 525, UE 115-h may store an SPS configuration. The SPS configuration may be a new active SPS configuration or may be an update to a previously stored SPS configuration. In some examples, UE 115-g and 115-h will identify additional SPS parameters to be applied to the SPS configuration, the additional SPS parameters including at least one of a set of SPS configuration indices, a radio network temporary identifier (RNTI) for activation, deactivation, or retransmission of SPS transmissions, a periodicity of SPS transmissions, or a maximum number of times that a transport block is to be transmitted in accordance with the SPS configuration, where the additional SPS parameters are either received from the base station or transmitted from the transmitting UE to the receiving UE.

At 530, UE 115-g may transmit and UE 115-h may receive SPS traffic after determining, based on the feedback information, that the SPS configuration is active. In some cases, transmitting the SPS traffic may include refraining from transmitting, based on the SPS configuration being active, at least one of additional first SCI messages or additional second SCI messages in connection with downlink transmissions scheduled in accordance with the SPS configuration. In some examples, the refraining may include refraining from transmitting both additional first SCI messages and additional second SCI messages in connection with downlink transmissions scheduled in accordance with the SPS configuration based on the UE operating in a first sidelink mode, or refraining from transmitting additional second SCI messages while still transmitting additional first SCI messages in connection with downlink transmissions scheduled in accordance with the SPS configuration based on the UE operating in a second sidelink mode. In some examples, SPS traffic may be retransmitted by UE 115-g based on receiving a NACK from UE 115-h.

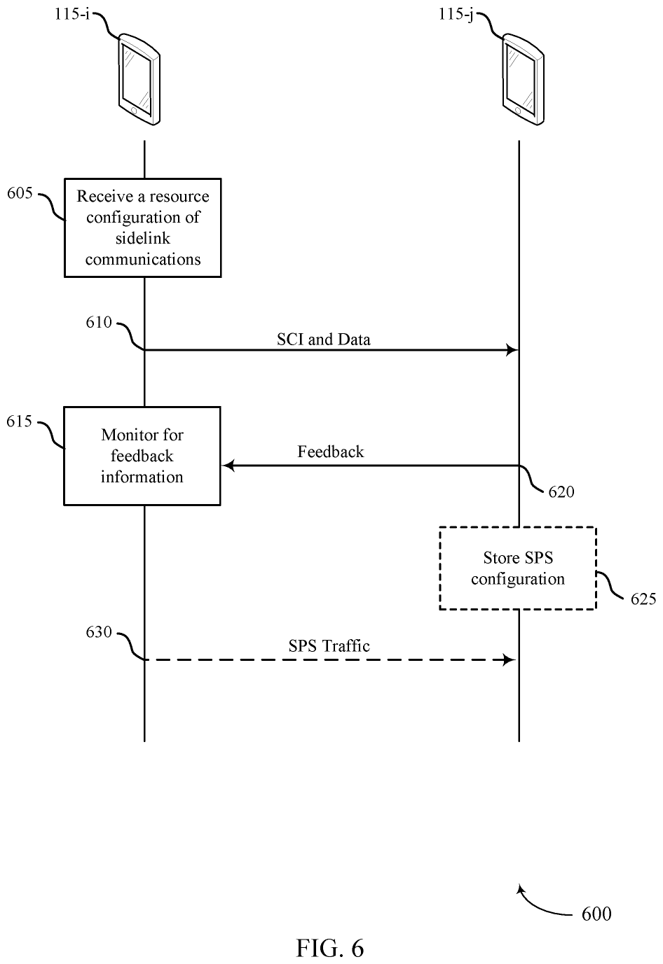

FIG. 6 illustrates an example of a process flow 600 that supports SPS of sidelink communications in accordance with aspects of the present disclosure. In some examples, process flow 600 may implement aspects of wireless communications system 100. Process flow 600 may include UEs 115-i and 115-j , which may be examples of a UE 115 as described herein with reference to FIGS. 1-4. For example, UE 115-i may be an example of UE 115-a as described with reference to FIG. 2, and UE 115-j may be an example of UE 115-b as described with reference to FIG. 2.

In the following description of the process flow 600, the operations between UE 115-i and UE 115-j may be performed in a different order than the order shown, or the operations performed by UE 115-i and UE 115-j may be performed in different orders or at different times. Some operations may also be left out of the process flow 600, or other operations may be added to the process flow 600. It is to be understood that while UE 115-i and UE 115-j are shown performing a number of the operations of process flow 600, any wireless device may perform the operations shown.

At 605, UE 115-i may receive, from a base station, a resource configuration for sidelink communications. The resource configuration may allow UE 115-i to schedule sidelink resources or the base station may schedule the sidelink resources.

At 610, UE 115-i may transmit and UE 115-j may receive SCI via a first SCI message and a second SCI message and data, the SCI including one or more SPS indications pertaining to an SPS configuration for communications from the transmitting UE to the receiving UE based on the resource configuration. For example, UE 115-i may include, as one of the one or more SPS indications, an activation or deactivation indicator in either the first SCI message or the second SCI message, where the activation or deactivation indicator is indicative of the SPS configuration being either activated or deactivated, respectively. Additionally or alternatively, UE 115-i may include, as one of the one or more SPS indications, a configuration index in the second SCI message, where the configuration index is indicative of the SPS configuration. Additionally or alternatively, UE 115-i may include, as one of the one or more SPS indications, an SPS identifier in the first SCI message, where the SPS identifier is indicative that the SCI includes the SPS configuration. The data may be transmitted simultaneously with the SCI or may immediately follow the one or more SPS indications. Additional data may be transmitted by UE 115-i with SCI until the feedback at 620 is received.

At 615, UE 115-i may monitor for feedback information pertaining to the SCI prior to proceeding with semi-persistent scheduled sidelink transmissions in accordance with the one or more SPS indications. For example, a feedback message may indicate that the SPS configuration is active based on the SCI including the one or more SPS indications. At 620, UE 115-j may transmit and UE 115-i may receive feedback information associated with the SCI.

At 625, UE 115-j may store an SPS configuration. The SPS configuration may be a new active SPS configuration or may be an update to a previously stored SPS configuration. In some examples, UE 115-i and 115-j will identify additional SPS parameters to be applied to the SPS configuration, the additional SPS parameters including at least one of a set of SPS configuration indices, an RNTI for activation, deactivation, or retransmission of SPS transmissions, a periodicity of SPS transmissions, or a maximum number of times that a transport block is to be transmitted in accordance with the SPS configuration, where the additional SPS parameters are either received from the base station or transmitted from the transmitting UE to the receiving UE.

At 630, UE 115-i may transmit and UE 115-j may receive SPS traffic after determining, based on the feedback information, that the SPS configuration is active. In some cases, transmitting the SPS traffic may include refraining from transmitting, based on the SPS configuration being active, at least one of additional first SCI messages or additional second SCI messages in connection with downlink transmissions scheduled in accordance with the SPS configuration. In some examples, the refraining may include refraining from transmitting both additional first SCI messages and additional second SCI messages in connection with downlink transmissions scheduled in accordance with the SPS configuration based on the UE operating in a first sidelink mode, or refraining from transmitting additional second SCI messages while still transmitting additional first SCI messages in connection with downlink transmissions scheduled in accordance with the SPS configuration based on the UE operating in a second sidelink mode. In some examples, SPS traffic may be retransmitted by UE 115-i based on receiving a NACK from UE 115-j.

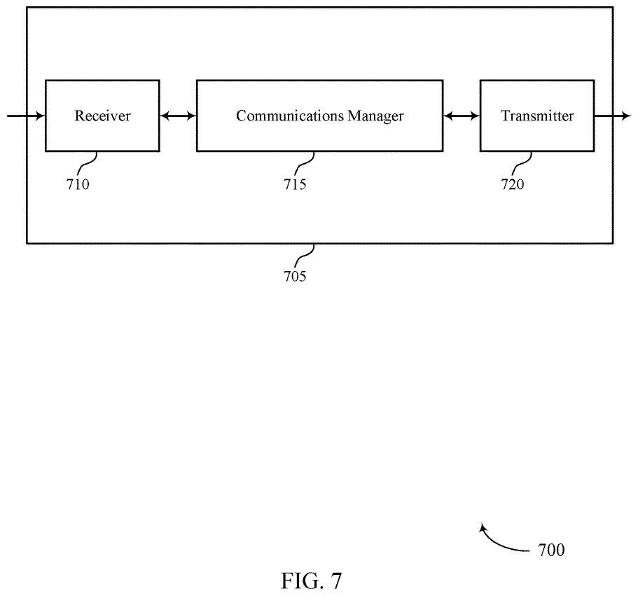

FIG. 7 shows a block diagram 700 of a device 705 that supports SPS of sidelink communications in accordance with aspects of the present disclosure. The device 705 may be an example of aspects of a UE 115 as described herein. The device 705 may include a receiver 710, a communications manager 715, and a transmitter 720. The device 705 may also include a processor. Each of these components may be in communication with one another (e.g., via one or more buses).

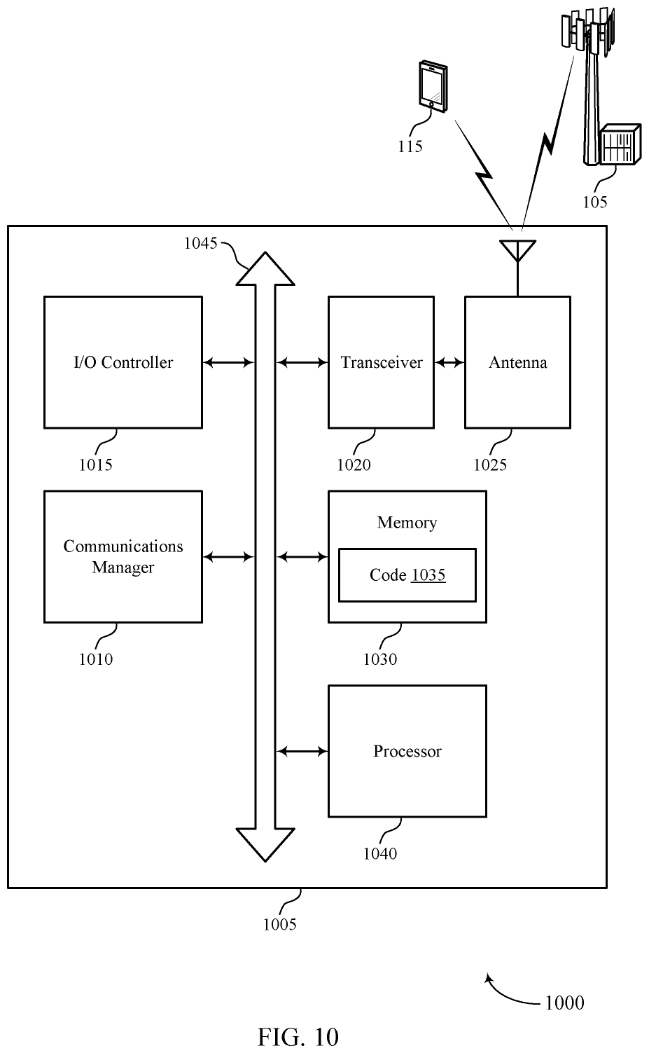

The receiver 710 may receive information such as packets, user data, or control information associated with various information channels (e.g., control channels, data channels, and information related to SPS of sidelink communications, etc.). Information may be passed on to other components of the device 705. The receiver 710 may be an example of aspects of the transceiver 1020 described with reference to FIG. 10. The receiver 710 may utilize a single antenna or a set of antennas.

The communications manager 715 may receive, from a base station, a resource configuration of sidelink communications, transmit, to a receiving UE, SCI via a first SCI message and a second SCI message, the SCI including one or more SPS indications pertaining to an SPS configuration for communications from the transmitting UE to the receiving UE based on the resource configuration, and monitor for feedback information pertaining to the SCI prior to proceeding with semi-persistent scheduled sidelink transmissions in accordance with the one or more SPS indications.

The communications manager 715 may also receive, from a transmitting UE on a sidelink channel, SCI including a first SCI message and a second SCI message, the SCI including one or more SPS indications pertaining to an SPS configuration for communications from the transmitting UE to the receiving UE and transmit, to the transmitting UE, feedback information associated with the SCI. The communications manager 715 may be an example of aspects of the communications manager 1010 described herein.

The communications manager 715, or its sub-components, may be implemented in hardware, code (e.g., software or firmware) executed by a processor, or any combination thereof. If implemented in code executed by a processor, the functions of the communications manager 715, or its sub-components may be executed by a general-purpose processor, a digital signal processor (DSP), an application-specific integrated circuit (ASIC), a field-programmable gate array (FPGA) or other programmable logic device, discrete gate or transistor logic, discrete hardware components, or any combination thereof designed to perform the functions described in the present disclosure.

The communications manager 715, or its sub-components, may be physically located at various positions, including being distributed such that portions of functions are implemented at different physical locations by one or more physical components. In some examples, the communications manager 715, or its sub-components, may be a separate and distinct component in accordance with various aspects of the present disclosure. In some examples, the communications manager 715, or its sub-components, may be combined with one or more other hardware components, including but not limited to an input/output (I/O) component, a transceiver, a network server, another computing device, one or more other components described in the present disclosure, or a combination thereof in accordance with various aspects of the present disclosure.

The transmitter 720 may transmit signals generated by other components of the device 705. In some examples, the transmitter 720 may be collocated with a receiver 710 in a transceiver. For example, the transmitter 720 may be an example of aspects of the transceiver 1020 described with reference to FIG. 10. The transmitter 720 may utilize a single antenna or a set of antennas.

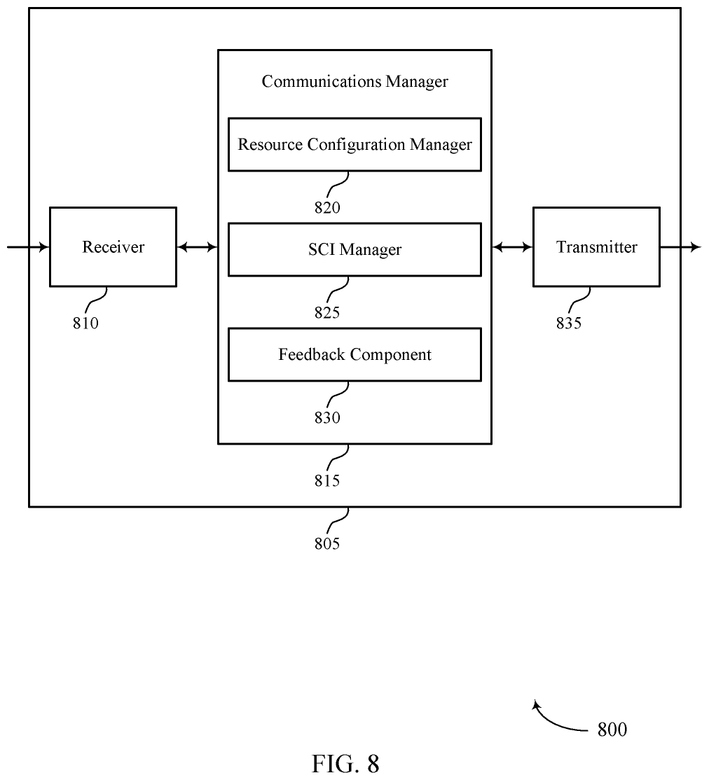

FIG. 8 shows a block diagram 800 of a device 805 that supports SPS of sidelink communications in accordance with aspects of the present disclosure. The device 805 may be an example of aspects of a device 705, or a UE 115 as described herein. The device 805 may include a receiver 810, a communications manager 815, and a transmitter 835. The device 805 may also include a processor. Each of these components may be in communication with one another (e.g., via one or more buses).

The receiver 810 may receive information such as packets, user data, or control information associated with various information channels (e.g., control channels, data channels, and information related to SPS of sidelink communications, etc.). Information may be passed on to other components of the device 805. The receiver 810 may be an example of aspects of the transceiver 1020 described with reference to FIG. 10. The receiver 810 may utilize a single antenna or a set of antennas.

The communications manager 815 may be an example of aspects of the communications manager 715 as described herein. The communications manager 815 may include a resource configuration manager 820, an SCI manager 825, and a feedback component 830. The communications manager 815 may be an example of aspects of the communications manager 1010 described herein.

The resource configuration manager 820 may receive, from a base station, a resource configuration of sidelink communications.

The SCI manager 825 may transmit, to a receiving UE, SCI via a first SCI message and a second SCI message, the SCI including one or more SPS indications pertaining to an SPS configuration for communications from the transmitting UE to the receiving UE based on the resource configuration. The SCI manager 825 may receive, from a transmitting UE on a sidelink channel, SCI including a first SCI message and a second SCI message, the SCI including one or more SPS indications pertaining to an SPS configuration for communications from the transmitting UE to the receiving UE.

The feedback component 830 may monitor for feedback information pertaining to the SCI prior to proceeding with semi-persistent scheduled sidelink transmissions in accordance with the one or more SPS indications. The feedback component 830 may transmit, to the transmitting UE, feedback information associated with the SCI.

The transmitter 835 may transmit signals generated by other components of the device 805. In some examples, the transmitter 835 may be collocated with a receiver 810 in a transceiver. For example, the transmitter 835 may be an example of aspects of the transceiver 1020 described with reference to FIG. 10. The transmitter 835 may utilize a single antenna or a set of antennas.

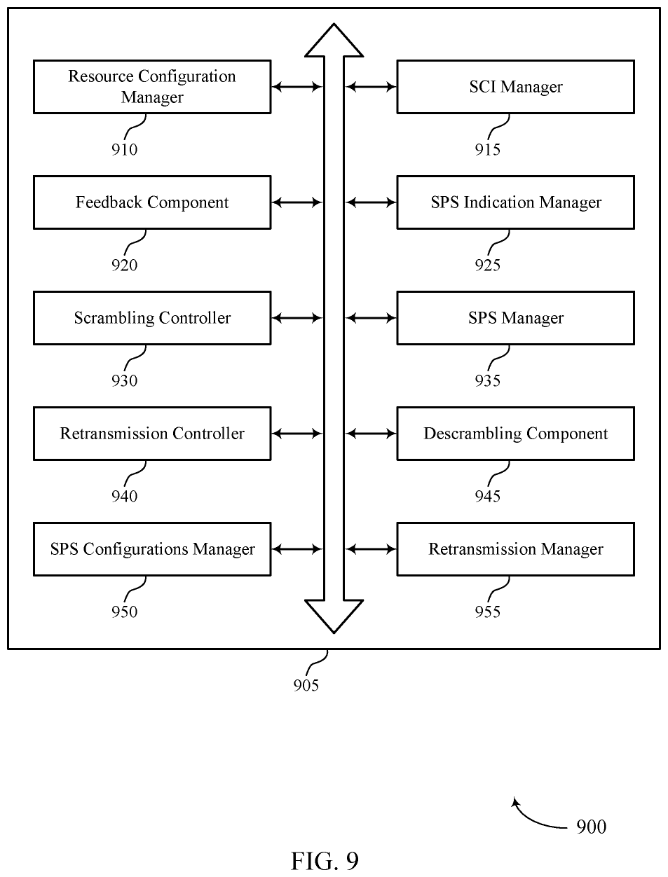

FIG. 9 shows a block diagram 900 of a communications manager 905 that supports SPS of sidelink communications in accordance with aspects of the present disclosure. The communications manager 905 may be an example of aspects of a communications manager 715, a communications manager 815, or a communications manager 1010 described herein. The communications manager 905 may include a resource configuration manager 910, an SCI manager 915, a feedback component 920, an SPS indication manager 925, a scrambling controller 930, an SPS manager 935, a retransmission controller 940, a descrambling component 945, an SPS configurations manager 950, and a retransmission manager 955. Each of these components may communicate, directly or indirectly, with one another (e.g., via one or more buses).

The resource configuration manager 910 may receive, from a base station, a resource configuration of sidelink communications.

The SCI manager 915 may transmit, to a receiving UE, SCI via a first SCI message and a second SCI message, the SCI including one or more SPS indications pertaining to an SPS configuration for communications from the transmitting UE to the receiving UE based on the resource configuration. In some examples, the SCI manager 915 may receive, from a transmitting UE on a sidelink channel, SCI including a first SCI message and a second SCI message, the SCI including one or more SPS indications pertaining to an SPS configuration for communications from the transmitting UE to the receiving UE. In some examples, the SCI manager 915 may refrain from transmitting, based on the SPS configuration being active, at least one of additional first SCI messages or additional second SCI messages in connection with downlink transmissions scheduled in accordance with the SPS configuration.

In some examples, the SCI manager 915 may refrain from transmitting both additional first SCI messages and additional second SCI messages in connection with downlink transmissions scheduled in accordance with the SPS configuration based on the UE operating in a first sidelink mode. In some examples, the SCI manager 915 may refrain from transmitting additional second SCI messages while still transmitting additional first SCI messages in connection with downlink transmissions scheduled in accordance with the SPS configuration based on the UE operating in a second sidelink mode. In some examples, the SCI manager 915 may transmit, to the receiving UE and via an additional first SCI message and an additional second SCI message, a second SCI including additional one or more SPS indications for modifying an active SPS configuration with the receiving UE. In some examples, the SCI manager 915 may transmit, to the receiving UE and via at least one of an additional first SCI message or an additional second SCI message, a second SCI including additional one or more SPS indications for deactivating an active SPS configuration with the receiving UE.

The feedback component 920 may monitor for feedback information pertaining to the SCI prior to proceeding with semi-persistent scheduled sidelink transmissions in accordance with the one or more SPS indications. In some examples, the feedback component 920 may transmit, to the transmitting UE, feedback information associated with the SCI. In some examples, the feedback component 920 may receive, from the receiving UE, a feedback message indicating the SPS configuration is active based on the SCI including the one or more SPS indications. In some examples, the feedback component 920 may receive, from the receiving UE, an ACK indicating the SPS configuration is active and indicating that a data transmission from the transmitting UE was successful.

In some examples, the feedback component 920 may receive, from the receiving UE, a NACK indicating the SPS configuration is active and indicating that a data transmission from the transmitting UE was unsuccessful. In some examples, the feedback component 920 may transmit, to the transmitting UE, an ACK indicating the SPS configuration is active and indicating that a data transmission from the transmitting UE was successful. In some examples, the feedback component 920 may transmit, to the transmitting UE, a NACK indicating the SPS configuration is active and indicating that a data transmission from the transmitting UE was unsuccessful.

The SPS indication manager 925 may include, as one of the one or more SPS indications, an activation or deactivation indicator in either the first SCI message or the second SCI message, where the activation or deactivation indicator is indicative of the SPS configuration being either activated or deactivated, respectively. In some examples, the SPS indication manager 925 may include, as one of the one or more SPS indications, a configuration index in the second SCI message, where the configuration index is indicative of the SPS configuration.

In some examples, the SPS indication manager 925 may include, as one of the one or more SPS indications, an SPS identifier in the first SCI message, where the SPS identifier is indicative that the SCI includes the SPS configuration. In some examples, the SPS indication manager 925 may include at least one of the one or more SPS indications in one or more fields of either the first SCI message or the second SCI message, where the one or more fields are configured to be used for multiple purposes. In some examples, the SPS indication manager 925 may set each bit in a second SCI message format field of the first SCI message to “1” to indicate an SPS identifier. In some examples, the SPS indication manager 925 may set a new data indicator in the first and/or second SCI message to “0” and include a valid frequency and time resource assignment in the first and/or second SCI message to indicate activation of the SPS configuration. In other examples, the SPS indication manager 925 may set a redundancy version field in the first and/or second SCI message to “0” and include a valid frequency and time resource assignment in the first and/or second SCI message to indicate activation of the SPS configuration. In some examples, the SPS indication manager 925 may set a new data indicator in the second SCI message to “0” and set a frequency and time resource assignment in the first and/or second SCI message to all “0”s or all “1”s to indicate deactivation of the SPS configuration. In some examples, the SPS indication manager 925 may set a redundancy version field in the second SCI message to “0” and set a frequency and time resource assignment in the first and/or second SCI message to all “0”s or all “1”s to indicate deactivation of the SPS configuration. In some examples, the SPS indication manager 925 may set one or more bits of a hybrid automatic repeat request process identifier field of the second SCI message to indicate an index of the SPS configuration.

In some examples, the SPS indication manager 925 may include at least one of the one or more SPS indications in a field of either the first SCI message or the second SCI message, where the field is dedicated to SPS indication use.

In some examples, the SPS indication manager 925 may receive, as one of the one or more SPS indications, an activation or deactivation indicator in either the first SCI message or the second SCI message, where the activation or deactivation indicator is indicative of the SPS configuration being either activated or deactivated, respectively. In some examples, the SPS indication manager 925 may receive, as one of the one or more SPS indications, a configuration index in the second SCI message, where the configuration index is indicative of the SPS configuration. In some examples, the SPS indication manager 925 may receive, as one of the one or more SPS indications, an SPS identifier in the first SCI message, where the SPS identifier is indicative that the SCI includes the SPS configuration.

In some examples, the SPS indication manager 925 may receive at least one of the one or more SPS indications in one or more fields of either the first SCI message or the second SCI message, where the one or more fields are configured to be used for multiple purposes. In some examples, the SPS indication manager 925 may receive each bit in a second SCI message format field of the first SCI message of “1” indicating an SPS identifier. In some examples, the SPS indication manager 925 may receive a new data indicator in the second SCI message of “0” and a valid frequency and time resource assignment in the first and/or second SCI message indicating activation of the SPS configuration. In some examples, the SPS indication manager 925 may receive a new data indicator in the second SCI message of “0” and a frequency and time resource assignment in the first and/or second SCI message of all “0”s or all “1”s indicating deactivation of the SPS configuration. In some examples, the SPS indication manager 925 may receive one or more bits of a hybrid automatic repeat request process identifier field of the second SCI message indicating an index of the SPS configuration.

In some examples, the SPS indication manager 925 may receive at least one of the one or more SPS indications in a field of either the first SCI message or the second SCI message, where the field is dedicated to SPS indication use.

In some examples, the SPS indication manager 925 may receive, via an additional first SCI message and an additional second SCI message, a second SCI including additional one or more SPS indications for modifying an active SPS configuration with the transmitting UE. In some examples, the SPS indication manager 925 may receive, via at least one of an additional first SCI message or an additional second SCI message, a second SCI including additional one or more SPS indications for deactivating an active SPS configuration with the transmitting UE.

The scrambling controller 930 may scramble a cyclic redundancy check with an SL-SPS-RNTI, where the SPS identifier is the scrambling of the cyclic redundancy check with the SL-SPS-RNTI.

The SPS manager 935 may determine, based on the feedback information, that the SPS configuration is active. In some examples, the SPS manager 935 may determine that the SPS configuration is to be updated. In some examples, the SPS manager 935 may determine that the SPS configuration is to be deactivated. In some examples, the SPS manager 935 may identify additional SPS parameters to be applied to the SPS configuration, the additional SPS parameters including at least one of a set of SPS configuration indices, a radio network temporary identifier for activation, deactivation, or retransmission of SPS transmissions, a periodicity of SPS transmissions, or a maximum number of times that a transport block is to be transmitted in accordance with the SPS configuration, where the additional SPS parameters are either received from the base station or transmitted from the transmitting UE to the receiving UE.

The retransmission controller 940 may transmit a retransmission of the data based on the NACK. In some examples, the retransmission controller 940 may transmit the retransmission of the data on semi-persistent scheduled resources according to the SPS configuration. In some examples, the retransmission controller 940 may transmit the retransmission of the data on dynamically scheduled resources.

The descrambling component 945 may descramble a cyclic redundancy check with an SL-SPS-RNTI, where the SPS identifier is the scrambling of the cyclic redundancy check with the SL-SPS-RNTI.

The SPS configurations manager 950 may store the SPS configuration and the one or more SPS indications based on successfully receiving the SCI. In some examples, the SPS configurations manager 950 may modify the SPS configuration based on the second SCI. In some examples, the SPS configurations manager 950 may deactivate the SPS configuration based on the second SCI. In some examples, the SPS configurations manager 950 may identify additional SPS parameters to be applied to the SPS configuration, the additional SPS parameters including at least one of a set of SPS configuration indices, a radio network temporary identifier for activation, deactivation, or retransmission of SPS transmissions, a periodicity of SPS transmissions, or a maximum number of times that a transport block is to be transmitted in accordance with the SPS configuration, where the additional SPS parameters are either received from the base station or transmitted from the transmitting UE to the receiving UE.

The retransmission manager 955 may receive a retransmission of the data based on the NACK. In some examples, the retransmission manager 955 may receive the retransmission of the data on semi-persistent scheduled resources according to the SPS configuration. In some examples, the retransmission manager 955 may receive the retransmission of the data on dynamically scheduled resources.

FIG. 10 shows a diagram of a system 1000 including a device 1005 that supports SPS of sidelink communications in accordance with aspects of the present disclosure. The device 1005 may be an example of or include the components of device 705, device 805, or a UE 115 as described herein. The device 1005 may include components for bi-directional voice and data communications including components for transmitting and receiving communications, including a communications manager 1010, an I/O controller 1015, a transceiver 1020, an antenna 1025, memory 1030, and a processor 1040. These components may be in electronic communication via one or more buses (e.g., bus 1045).

The communications manager 1010 may receive, from a base station, a resource configuration of sidelink communications, transmit, to a receiving UE, SCI via a first SCI message and a second SCI message, the SCI including one or more SPS indications pertaining to an SPS configuration for communications from the transmitting UE to the receiving UE based on the resource configuration, and monitor for feedback information pertaining to the SCI prior to proceeding with semi-persistent scheduled sidelink transmissions in accordance with the one or more SPS indications.

The communications manager 1010 may also receive, from a transmitting UE on a sidelink channel, SCI including a first SCI message and a second SCI message, the SCI including one or more SPS indications pertaining to an SPS configuration for communications from the transmitting UE to the receiving UE and transmit, to the transmitting UE, feedback information associated with the SCI.

The I/O controller 1015 may manage input and output signals for the device 1005. The I/O controller 1015 may also manage peripherals not integrated into the device 1005. In some cases, the I/O controller 1015 may represent a physical connection or port to an external peripheral. In some cases, the I/O controller 1015 may utilize an operating system such as iOS®, ANDROID®, MS-DOS®, MS-WINDOWS®, OS/2®, UNIX®, LINUX®, or another known operating system. In other cases, the I/0 controller 1015 may represent or interact with a modem, a keyboard, a mouse, a touchscreen, or a similar device. In some cases, the I/O controller 1015 may be implemented as part of a processor. In some cases, a user may interact with the device 1005 via the I/O controller 1015 or via hardware components controlled by the I/O controller 1015.

The transceiver 1020 may communicate bi-directionally, via one or more antennas, wired, or wireless links as described above. For example, the transceiver 1020 may represent a wireless transceiver and may communicate bi-directionally with another wireless transceiver. The transceiver 1020 may also include a modem to modulate the packets and provide the modulated packets to the antennas for transmission, and to demodulate packets received from the antennas.

In some cases, the wireless device may include a single antenna 1025. However, in some cases the device may have more than one antenna 1025, which may be capable of concurrently transmitting or receiving multiple wireless transmissions.

The memory 1030 may include random-access memory (RAM) and read-only memory (ROM). The memory 1030 may store computer-readable, computer-executable code 1035 including instructions that, when executed, cause the processor to perform various functions described herein. In some cases, the memory 1030 may contain, among other things, a basic I/O system (BIOS) which may control basic hardware or software operation such as the interaction with peripheral components or devices.

The processor 1040 may include an intelligent hardware device, (e.g., a general-purpose processor, a DSP, a central processing unit (CPU), a microcontroller, an ASIC, an FPGA, a programmable logic device, a discrete gate or transistor logic component, a discrete hardware component, or any combination thereof). In some cases, the processor 1040 may be configured to operate a memory array using a memory controller. In other cases, a memory controller may be integrated into the processor 1040. The processor 1040 may be configured to execute computer-readable instructions stored in a memory (e.g., the memory 1030) to cause the device 1005 to perform various functions (e.g., functions or tasks supporting SPS of sidelink communications).

The code 1035 may include instructions to implement aspects of the present disclosure, including instructions to support wireless communications. The code 1035 may be stored in a non-transitory computer-readable medium such as system memory or other type of memory. In some cases, the code 1035 may not be directly executable by the processor 1040 but may cause a computer (e.g., when compiled and executed) to perform functions described herein.

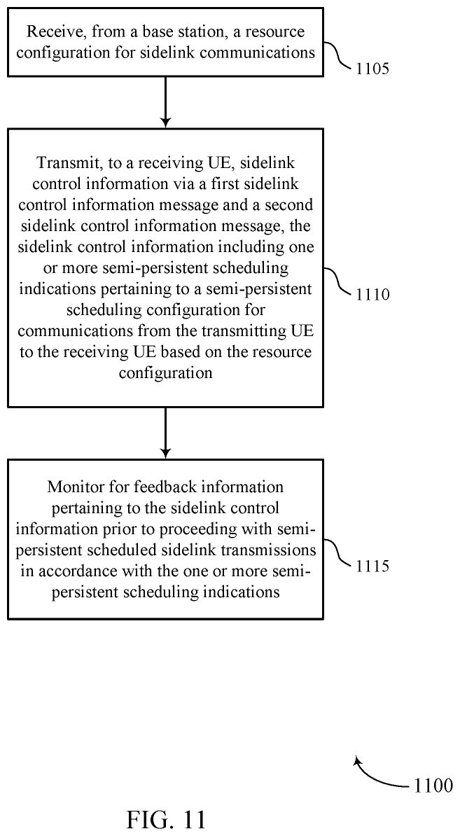

FIG. 11 shows a flowchart illustrating a method 1100 that supports SPS of sidelink communications in accordance with aspects of the present disclosure. The operations of method 1100 may be implemented by a UE 115 or its components as described herein. For example, the operations of method 1100 may be performed by a communications manager as described with reference to FIGS. 7 through 10. In some examples, a UE may execute a set of instructions to control the functional elements of the UE to perform the functions described below. Additionally or alternatively, a UE may perform aspects of the functions described below using special-purpose hardware.

At 1105, the UE may receive, from a base station, a resource configuration of sidelink communications. The operations of 1105 may be performed according to the methods described herein. In some examples, aspects of the operations of 1105 may be performed by a resource configuration manager as described with reference to FIGS. 7 through 10.

At 1110, the UE may transmit, to a receiving UE, SCI via a first SCI message and a second SCI message, the SCI including one or more SPS indications pertaining to a SPS configuration for communications from the transmitting UE to the receiving UE based on the resource configuration. The operations of 1110 may be performed according to the methods described herein. In some examples, aspects of the operations of 1110 may be performed by an SCI manager as described with reference to FIGS. 7 through 10.

At 1115, the UE may monitor for feedback information pertaining to the SCI prior to proceeding with semi-persistent scheduled sidelink transmissions in accordance with the one or more SPS indications. The operations of 1115 may be performed according to the methods described herein. In some examples, aspects of the operations of 1115 may be performed by a feedback component as described with reference to FIGS. 7 through 10.

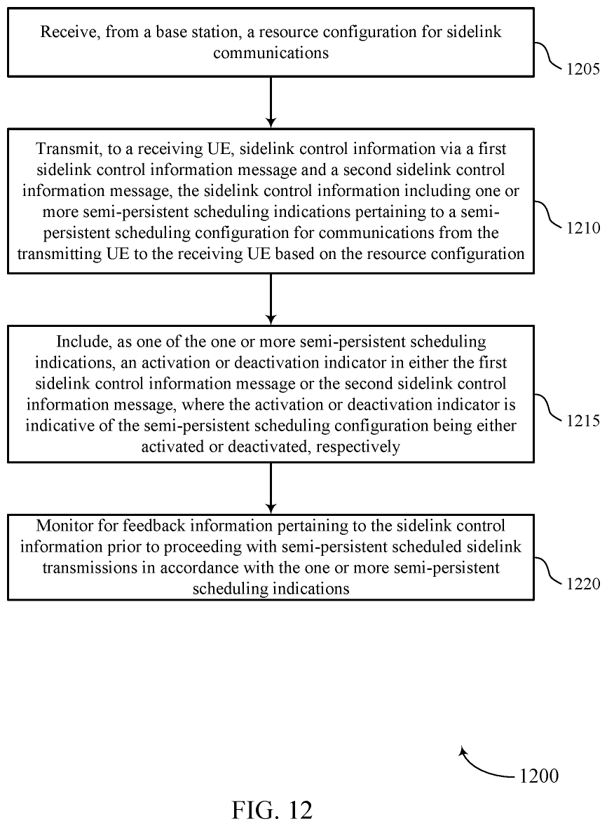

FIG. 12 shows a flowchart illustrating a method 1200 that supports SPS of sidelink communications in accordance with aspects of the present disclosure. The operations of method 1200 may be implemented by a UE 115 or its components as described herein. For example, the operations of method 1200 may be performed by a communications manager as described with reference to FIGS. 7 through 10. In some examples, a UE may execute a set of instructions to control the functional elements of the UE to perform the functions described below. Additionally or alternatively, a UE may perform aspects of the functions described below using special-purpose hardware.

At 1205, the UE may receive, from a base station, a resource configuration of sidelink communications. The operations of 1205 may be performed according to the methods described herein. In some examples, aspects of the operations of 1205 may be performed by a resource configuration manager as described with reference to FIGS. 7 through 10.

At 1210, the UE may transmit, to a receiving UE, SCI via a first SCI message and a second SCI message, the SCI including one or more SPS indications pertaining to a SPS configuration for communications from the transmitting UE to the receiving UE based on the resource configuration. The operations of 1210 may be performed according to the methods described herein. In some examples, aspects of the operations of 1210 may be performed by an SCI manager as described with reference to FIGS. 7 through 10.

At 1215, the UE may include, as one of the one or more SPS indications, an activation or deactivation indicator in either the first SCI message or the second SCI message, where the activation or deactivation indicator is indicative of the SPS configuration being either activated or deactivated, respectively. The operations of 1215 may be performed according to the methods described herein. In some examples, aspects of the operations of 1215 may be performed by an SPS indication manager as described with reference to FIGS. 7 through 10.

At 1220, the UE may monitor for feedback information pertaining to the SCI prior to proceeding with semi-persistent scheduled sidelink transmissions in accordance with the one or more SPS indications. The operations of 1220 may be performed according to the methods described herein. In some examples, aspects of the operations of 1220 may be performed by a feedback component as described with reference to FIGS. 7 through 10.

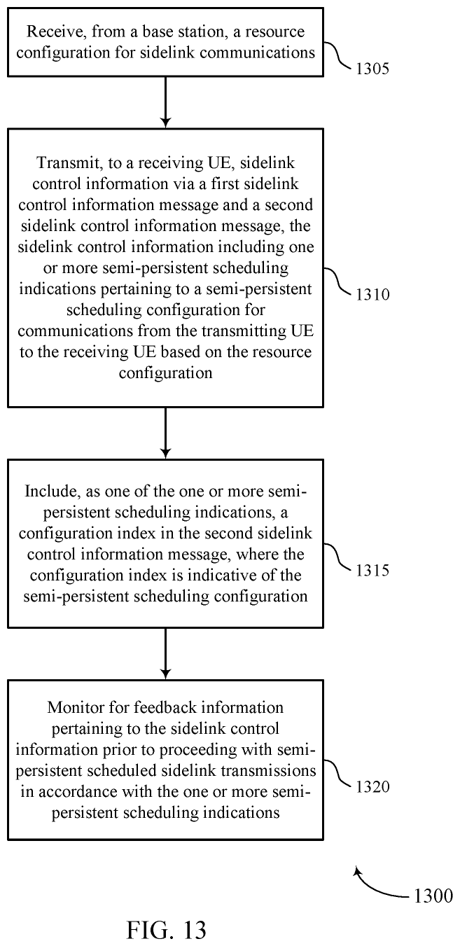

FIG. 13 shows a flowchart illustrating a method 1300 that supports SPS of sidelink communications in accordance with aspects of the present disclosure. The operations of method 1300 may be implemented by a UE 115 or its components as described herein. For example, the operations of method 1300 may be performed by a communications manager as described with reference to FIGS. 7 through 10. In some examples, a UE may execute a set of instructions to control the functional elements of the UE to perform the functions described below. Additionally or alternatively, a UE may perform aspects of the functions described below using special-purpose hardware.

At 1305, the UE may receive, from a base station, a resource configuration of sidelink communications. The operations of 1305 may be performed according to the methods described herein. In some examples, aspects of the operations of 1305 may be performed by a resource configuration manager as described with reference to FIGS. 7 through 10.

At 1310, the UE may transmit, to a receiving UE, SCI via a first SCI message and a second SCI message, the SCI including one or more SPS indications pertaining to a SPS configuration for communications from the transmitting UE to the receiving UE based on the resource configuration. The operations of 1310 may be performed according to the methods described herein. In some examples, aspects of the operations of 1310 may be performed by an SCI manager as described with reference to FIGS. 7 through 10.

At 1315, the UE may include, as one of the one or more SPS indications, a configuration index in the second SCI message, where the configuration index is indicative of the SPS configuration. The operations of 1315 may be performed according to the methods described herein. In some examples, aspects of the operations of 1315 may be performed by an SPS indication manager as described with reference to FIGS. 7 through 10.

At 1320, the UE may monitor for feedback information pertaining to the SCI prior to proceeding with semi-persistent scheduled sidelink transmissions in accordance with the one or more SPS indications. The operations of 1320 may be performed according to the methods described herein. In some examples, aspects of the operations of 1320 may be performed by a feedback component as described with reference to FIGS. 7 through 10.

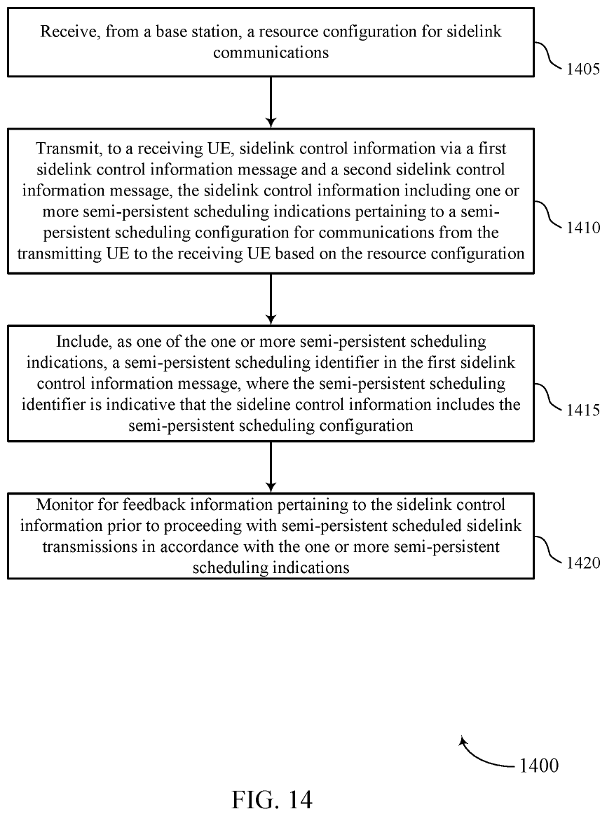

FIG. 14 shows a flowchart illustrating a method 1400 that supports SPS of sidelink communications in accordance with aspects of the present disclosure. The operations of method 1400 may be implemented by a UE 115 or its components as described herein. For example, the operations of method 1400 may be performed by a communications manager as described with reference to FIGS. 7 through 10. In some examples, a UE may execute a set of instructions to control the functional elements of the UE to perform the functions described below. Additionally or alternatively, a UE may perform aspects of the functions described below using special-purpose hardware.

At 1405, the UE may receive, from a base station, a resource configuration of sidelink communications. The operations of 1405 may be performed according to the methods described herein. In some examples, aspects of the operations of 1405 may be performed by a resource configuration manager as described with reference to FIGS. 7 through 10.

At 1410, the UE may transmit, to a receiving UE, SCI via a first SCI message and a second SCI message, the SCI including one or more SPS indications pertaining to a SPS configuration for communications from the transmitting UE to the receiving UE based on the resource configuration. The operations of 1410 may be performed according to the methods described herein. In some examples, aspects of the operations of 1410 may be performed by an SCI manager as described with reference to FIGS. 7 through 10.

At 1415, the UE may include, as one of the one or more SPS indications, a SPS identifier in the first SCI message, where the SPS identifier is indicative that the SCI includes the SPS configuration. The operations of 1415 may be performed according to the methods described herein. In some examples, aspects of the operations of 1415 may be performed by an SPS indication manager as described with reference to FIGS. 7 through 10.

At 1420, the UE may monitor for feedback information pertaining to the SCI prior to proceeding with semi-persistent scheduled sidelink transmissions in accordance with the one or more SPS indications. The operations of 1420 may be performed according to the methods described herein. In some examples, aspects of the operations of 1420 may be performed by a feedback component as described with reference to FIGS. 7 through 10.

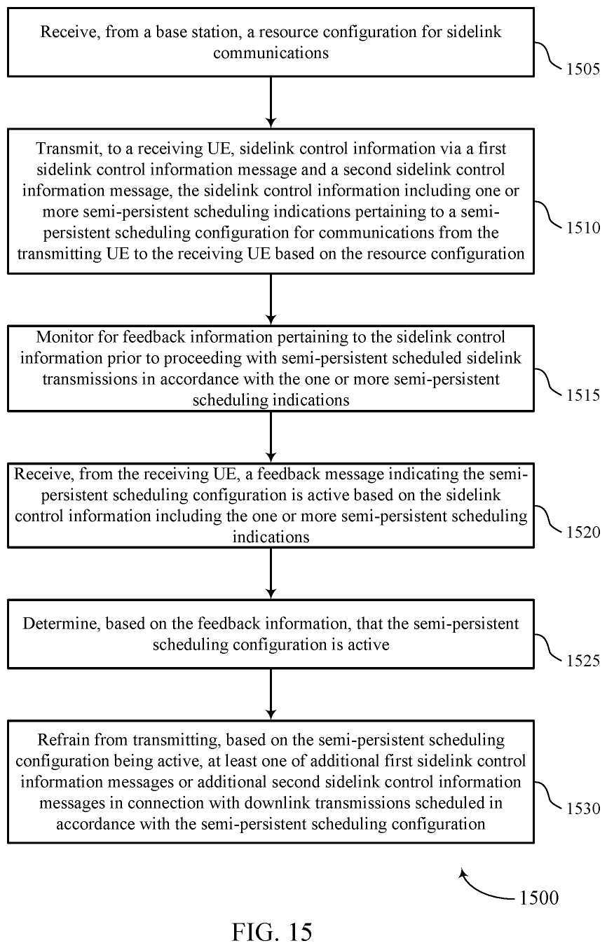

FIG. 15 shows a flowchart illustrating a method 1500 that supports SPS of sidelink communications in accordance with aspects of the present disclosure. The operations of method 1500 may be implemented by a UE 115 or its components as described herein. For example, the operations of method 1500 may be performed by a communications manager as described with reference to FIGS. 7 through 10. In some examples, a UE may execute a set of instructions to control the functional elements of the UE to perform the functions described below. Additionally or alternatively, a UE may perform aspects of the functions described below using special-purpose hardware.

At 1505, the UE may receive, from a base station, a resource configuration of sidelink communications. The operations of 1505 may be performed according to the methods described herein. In some examples, aspects of the operations of 1505 may be performed by a resource configuration manager as described with reference to FIGS. 7 through 10.

At 1510, the UE may transmit, to a receiving UE, SCI via a first SCI message and a second SCI message, the SCI including one or more SPS indications pertaining to a SPS configuration for communications from the transmitting UE to the receiving UE based on the resource configuration. The operations of 1510 may be performed according to the methods described herein. In some examples, aspects of the operations of 1510 may be performed by an SCI manager as described with reference to FIGS. 7 through 10.

At 1515, the UE may monitor for feedback information pertaining to the SCI prior to proceeding with semi-persistent scheduled sidelink transmissions in accordance with the one or more SPS indications. The operations of 1515 may be performed according to the methods described herein. In some examples, aspects of the operations of 1515 may be performed by a feedback component as described with reference to FIGS. 7 through 10.

At 1520, the UE may receive, from the receiving UE, a feedback message indicating the SPS configuration is active based on the SCI including the one or more SPS indications. The operations of 1520 may be performed according to the methods described herein. In some examples, aspects of the operations of 1520 may be performed by a feedback component as described with reference to FIGS. 7 through 10.

At 1525, the UE may determine, based on the feedback information, that the SPS configuration is active. The operations of 1525 may be performed according to the methods described herein. In some examples, aspects of the operations of 1525 may be performed by an SPS manager as described with reference to FIGS. 7 through 10.

At 1530, the UE may refrain from transmitting, based on the SPS configuration being active, at least one of additional first SCI messages or additional second SCI messages in connection with downlink transmissions scheduled in accordance with the SPS configuration. The operations of 1530 may be performed according to the methods described herein. In some examples, aspects of the operations of 1530 may be performed by an SCI manager as described with reference to FIGS. 7 through 10.

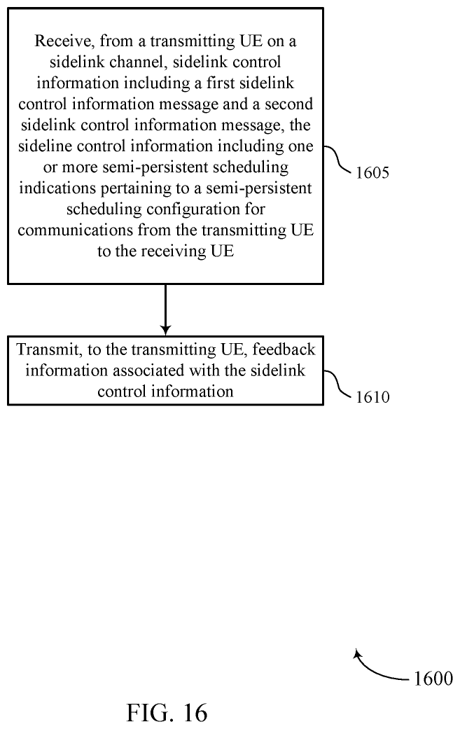

FIG. 16 shows a flowchart illustrating a method 1600 that supports SPS of sidelink communications in accordance with aspects of the present disclosure. The operations of method 1600 may be implemented by a UE 115 or its components as described herein. For example, the operations of method 1600 may be performed by a communications manager as described with reference to FIGS. 7 through 10. In some examples, a UE may execute a set of instructions to control the functional elements of the UE to perform the functions described below. Additionally or alternatively, a UE may perform aspects of the functions described below using special-purpose hardware.

At 1605, the UE may receive, from a transmitting UE on a sidelink channel, SCI including a first SCI message and a second SCI message, the SCI including one or more SPS indications pertaining to a SPS configuration for communications from the transmitting UE to the receiving UE. The operations of 1605 may be performed according to the methods described herein. In some examples, aspects of the operations of 1605 may be performed by an SCI manager as described with reference to FIGS. 7 through 10.

At 1610, the UE may transmit, to the transmitting UE, feedback information associated with the SCI. The operations of 1610 may be performed according to the methods described herein. In some examples, aspects of the operations of 1610 may be performed by a feedback component as described with reference to FIGS. 7 through 10.

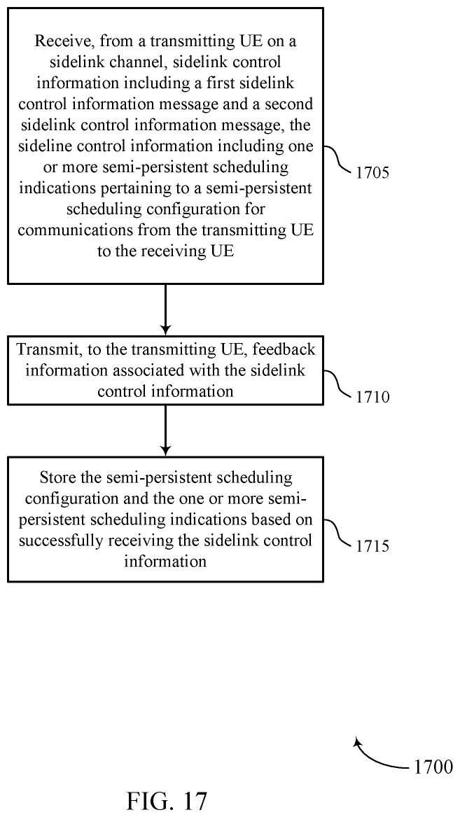

FIG. 17 shows a flowchart illustrating a method 1700 that supports SPS of sidelink communications in accordance with aspects of the present disclosure. The operations of method 1700 may be implemented by a UE 115 or its components as described herein. For example, the operations of method 1700 may be performed by a communications manager as described with reference to FIGS. 7 through 10. In some examples, a UE may execute a set of instructions to control the functional elements of the UE to perform the functions described below. Additionally or alternatively, a UE may perform aspects of the functions described below using special-purpose hardware.

At 1705, the UE may receive, from a transmitting UE on a sidelink channel, SCI including a first SCI message and a second SCI message, the SCI including one or more SPS indications pertaining to a SPS configuration for communications from the transmitting UE to the receiving UE. The operations of 1705 may be performed according to the methods described herein. In some examples, aspects of the operations of 1705 may be performed by an SCI manager as described with reference to FIGS. 7 through 10.

At 1710, the UE may transmit, to the transmitting UE, feedback information associated with the SCI. The operations of 1710 may be performed according to the methods described herein. In some examples, aspects of the operations of 1710 may be performed by a feedback component as described with reference to FIGS. 7 through 10.

At 1715, the UE may store the SPS configuration and the one or more SPS indications based on successfully receiving the SCI. The operations of 1715 may be performed according to the methods described herein. In some examples, aspects of the operations of 1715 may be performed by an SPS configurations manager as described with reference to FIGS. 7 through 10.

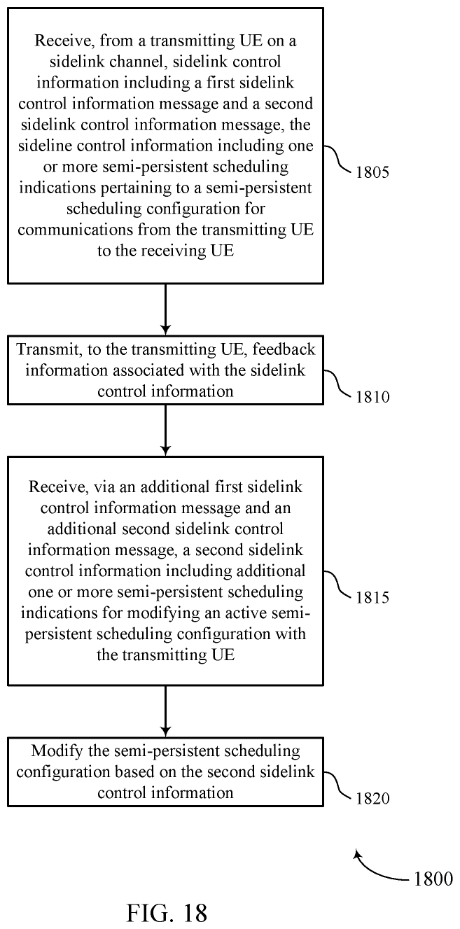

FIG. 18 shows a flowchart illustrating a method 1800 that supports SPS of sidelink communications in accordance with aspects of the present disclosure. The operations of method 1800 may be implemented by a UE 115 or its components as described herein. For example, the operations of method 1800 may be performed by a communications manager as described with reference to FIGS. 7 through 10. In some examples, a UE may execute a set of instructions to control the functional elements of the UE to perform the functions described below. Additionally or alternatively, a UE may perform aspects of the functions described below using special-purpose hardware.

At 1805, the UE may receive, from a transmitting UE on a sidelink channel, SCI including a first SCI message and a second SCI message, the SCI including one or more SPS indications pertaining to a SPS configuration for communications from the transmitting UE to the receiving UE. The operations of 1805 may be performed according to the methods described herein. In some examples, aspects of the operations of 1805 may be performed by an SCI manager as described with reference to FIGS. 7 through 10.

At 1810, the UE may transmit, to the transmitting UE, feedback information associated with the SCI. The operations of 1810 may be performed according to the methods described herein. In some examples, aspects of the operations of 1810 may be performed by a feedback component as described with reference to FIGS. 7 through 10.

At 1815, the UE may receive, via an additional first SCI message and an additional second SCI message, a second SCI including additional one or more SPS indications for modifying an active SPS configuration with the transmitting UE. The operations of 1815 may be performed according to the methods described herein. In some examples, aspects of the operations of 1815 may be performed by an SPS indication manager as described with reference to FIGS. 7 through 10.

At 1820, the UE may modify the SPS configuration based on the second SCI. The operations of 1820 may be performed according to the methods described herein. In some examples, aspects of the operations of 1820 may be performed by an SPS configurations manager as described with reference to FIGS. 7 through 10.

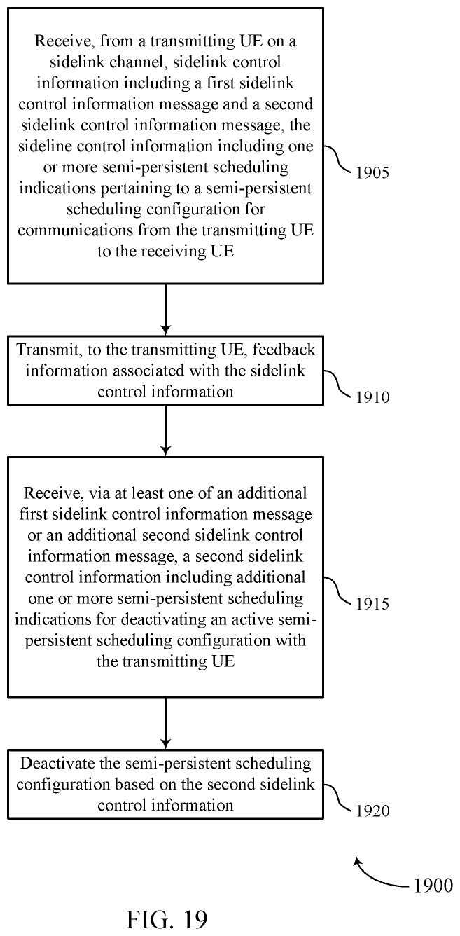

FIG. 19 shows a flowchart illustrating a method 1900 that supports SPS of sidelink communications in accordance with aspects of the present disclosure. The operations of method 1900 may be implemented by a UE 115 or its components as described herein. For example, the operations of method 1900 may be performed by a communications manager as described with reference to FIGS. 7 through 10. In some examples, a UE may execute a set of instructions to control the functional elements of the UE to perform the functions described below. Additionally or alternatively, a UE may perform aspects of the functions described below using special-purpose hardware.

At 1905, the UE may receive, from a transmitting UE on a sidelink channel, SCI including a first SCI message and a second SCI message, the SCI including one or more SPS indications pertaining to a SPS configuration for communications from the transmitting UE to the receiving UE. The operations of 1905 may be performed according to the methods described herein. In some examples, aspects of the operations of 1905 may be performed by an SCI manager as described with reference to FIGS. 7 through 10.

At 1910, the UE may transmit, to the transmitting UE, feedback information associated with the SCI. The operations of 1910 may be performed according to the methods described herein. In some examples, aspects of the operations of 1910 may be performed by a feedback component as described with reference to FIGS. 7 through 10.

At 1915, the UE may receive, via at least one of an additional first SCI message or an additional second SCI message, a second SCI including additional one or more SPS indications for deactivating an active SPS configuration with the transmitting UE. The operations of 1915 may be performed according to the methods described herein. In some examples, aspects of the operations of 1915 may be performed by an SPS indication manager as described with reference to FIGS. 7 through 10.

At 1920, the UE may deactivate the SPS configuration based on the second SCI. The operations of 1920 may be performed according to the methods described herein. In some examples, aspects of the operations of 1920 may be performed by an SPS configurations manager as described with reference to FIGS. 7 through 10.

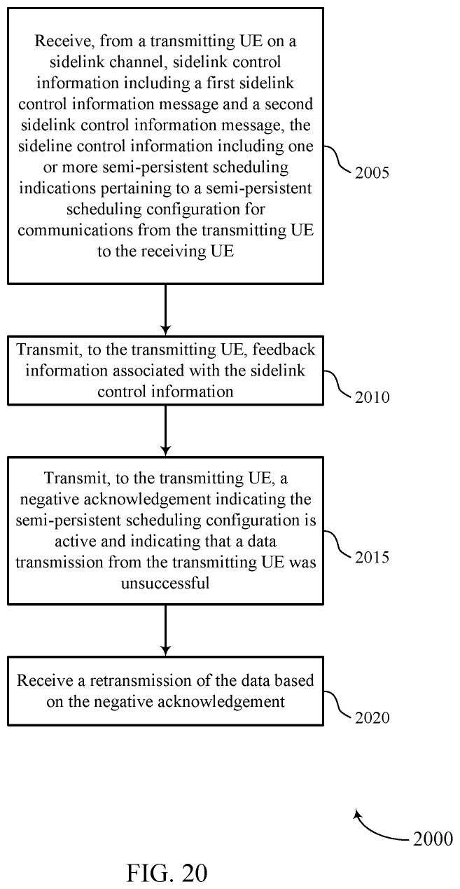

FIG. 20 shows a flowchart illustrating a method 2000 that supports SPS of sidelink communications in accordance with aspects of the present disclosure. The operations of method 2000 may be implemented by a UE 115 or its components as described herein. For example, the operations of method 2000 may be performed by a communications manager as described with reference to FIGS. 7 through 10. In some examples, a UE may execute a set of instructions to control the functional elements of the UE to perform the functions described below. Additionally or alternatively, a UE may perform aspects of the functions described below using special-purpose hardware.

At 2005, the UE may receive, from a transmitting UE on a sidelink channel, SCI including a first SCI message and a second SCI message, the SCI including one or more SPS indications pertaining to a SPS configuration for communications from the transmitting UE to the receiving UE. The operations of 2005 may be performed according to the methods described herein. In some examples, aspects of the operations of 2005 may be performed by an SCI manager as described with reference to FIGS. 7 through 10.

At 2010, the UE may transmit, to the transmitting UE, feedback information associated with the SCI. The operations of 2010 may be performed according to the methods described herein. In some examples, aspects of the operations of 2010 may be performed by a feedback component as described with reference to FIGS. 7 through 10.

At 2015, the UE may transmit, to the transmitting UE, a NACK indicating the SPS configuration is active and indicating that a data transmission from the transmitting UE was unsuccessful. The operations of 2015 may be performed according to the methods described herein. In some examples, aspects of the operations of 2015 may be performed by a feedback component as described with reference to FIGS. 7 through 10.

At 2020, the UE may receive a retransmission of the data based on the NACK. The operations of 2020 may be performed according to the methods described herein. In some examples, aspects of the operations of 2020 may be performed by a retransmission manager as described with reference to FIGS. 7 through 10.

It should be noted that the methods described herein describe possible implementations, and that the operations and the steps may be rearranged or otherwise modified and that other implementations are possible. Further, aspects from two or more of the methods may be combined.

The following provides an overview of aspects of the present disclosure:

Aspect 1: A method for wireless communications at a transmitting UE, comprising: receiving, from a base station, a resource configuration of sidelink communications; transmitting, to a receiving UE, SCI via one or more SCI messages, the SCI comprising one or more SPS indications pertaining to an SPS configuration for communications from the transmitting UE to the receiving UE based at least in part on the resource configuration; and monitoring for feedback information pertaining to the SCI prior to proceeding with semi-persistent scheduled sidelink transmissions in accordance with the one or more SPS indications.

Aspect 2: The method of aspect 1, wherein transmitting the SCI comprises: including, as one of the one or more SPS indications, an activation or deactivation indicator in the one or more SCI messages, wherein the activation or deactivation indicator is indicative of the SPS configuration being either activated or deactivated, respectively.

Aspect 3: The method of any of aspects 1 through 2, wherein transmitting the SCI comprises: including, as one of the one or more SPS indications, a configuration index in the one or more SCI messages, wherein the configuration index is indicative of the SPS configuration.

Aspect 4: The method of any of aspects 1 through 3, wherein transmitting the SCI comprises: including, as one of the one or more SPS indications, an SPS identifier in the one or more SCI messages, wherein the SPS identifier is indicative that the SCI includes the SPS configuration.

Aspect 5: The method of aspect 4, wherein including the SPS identifier in the one or more SCI messages comprises: scrambling a CRC with an SL-SPS-RNTI, wherein the SPS identifier is the scrambling of the CRC with the SL-SPS-RNTI.

Aspect 6: The method of any of aspects 1 through 5, wherein the one or more SCI messages comprise a first SCI message and a second SCI message, and wherein transmitting the SCI comprises: including at least one of the one or more SPS indications in one or more fields of either the first SCI message or the second SCI message, wherein the one or more fields are configured to be used for multiple purposes.

Aspect 7: The method of aspect 6, wherein including the at least one of the one or more SPS indications in the one or more fields comprises: setting each bit in a second SCI message format field of the first SCI message to “1” to indicate an SPS identifier.

Aspect 8: The method of any of aspects 6 through 7, wherein including the at least one of the one or more SPS indications in the one or more fields comprises: setting a new data indicator in the second SCI message to “0” and including a valid frequency and time resource assignment in the first SCI message to indicate activation of the SPS configuration.

Aspect 9: The method of any of aspects 6 through 8, wherein including the at least one of the one or more SPS indications in the one or more fields comprises: setting a new data indicator in the second SCI message to “0” and setting a frequency and time resource assignment in the first SCI message to all “0”s to indicate deactivation of the SPS configuration.

Aspect 10: The method of any of aspects 6 through 9, wherein including the at least one of the one or more SPS indications in the one or more fields comprises: setting one or more bits of a HARQ process identifier field of the second SCI message to indicate an index of the SPS configuration.

Aspect 11: The method of any of aspects 1 through 10, wherein transmitting the SCI comprises: including at least one of the one or more SPS indications in a field of the one or more SCI messages, wherein the field is dedicated to SPS indication use.

Aspect 12: The method of any of aspects 1 through 11, further comprising: receiving, from the receiving UE, a feedback message indicating the SPS configuration is active based at least in part on the SCI comprising the one or more SPS indications.

Aspect 13: The method of any of aspects 1 through 12, further comprising: determining, based on the feedback information, that the SPS configuration is active; and refraining from transmitting, based at least in part on the SPS configuration being active, at least one of additional first SCI messages or additional second SCI messages in connection with downlink transmissions scheduled in accordance with the SPS configuration.

Aspect 14: The method of aspect 13, wherein refraining from transmitting at least one of additional first SCI messages or additional second SCI messages in connection with downlink transmissions scheduled in accordance with the SPS configuration further comprises: refraining from transmitting both additional first SCI messages and additional second SCI messages in connection with downlink transmissions scheduled in accordance with the SPS configuration based at least in part on the UE operating in a first sidelink mode.

Aspect 15: The method of any of aspects 13 through 14, wherein refraining from transmitting at least one of additional first SCI messages or additional second SCI messages in connection with downlink transmissions scheduled in accordance with the SPS configuration further comprises: refraining from transmitting additional second SCI messages while still transmitting additional first SCI messages in connection with downlink transmissions scheduled in accordance with the SPS configuration based at least in part on the UE operating in a second sidelink mode.

Aspect 16: The method of any of aspects 1 through 15, further comprising: determining that the SPS configuration is to be updated; and transmitting, to the receiving UE and via one or more additional SCI messages, a second SCI comprising additional one or more SPS indications for modifying an active SPS configuration with the receiving UE.

Aspect 17: The method of any of aspects 1 through 16, further comprising: determining that the SPS configuration is to be deactivated; and transmitting, to the receiving UE and via one or more additional SCI messages, a second SCI comprising additional one or more SPS indications for deactivating an active SPS configuration with the receiving UE.

Aspect 18: The method of any of aspects 1 through 17, further comprising: identifying additional SPS parameters to be applied to the SPS configuration, the additional SPS parameters including at least one of a plurality of SPS configuration indices, a radio network temporary identifier for activation, deactivation, or retransmission of SPS transmissions, a periodicity of SPS transmissions, or a maximum number of times that a transport block is to be transmitted in accordance with the SPS configuration, wherein the additional SPS parameters are either received from the base station or transmitted from the transmitting UE to the receiving UE.

Aspect 19: The method of any of aspects 1 through 18, further comprising: receiving, from the receiving UE, a positive acknowledgement indicating the SPS configuration is active and indicating that a data transmission from the transmitting UE was successful.

Aspect 20: The method of any of aspects 1 through 19, further comprising: receiving, from the receiving UE, a NACK indicating the SPS configuration is active and indicating that a data transmission from the transmitting UE was unsuccessful; and transmitting a retransmission of the data based at least in part on the NACK.

Aspect 21: The method of aspect 20, wherein transmitting the retransmission of the data further comprises: transmitting the retransmission of the data on semi-persistent scheduled resources according to the SPS configuration.

Aspect 22: The method of any of aspects 20 through 21, wherein transmitting the retransmission of the data further comprises: transmitting the retransmission of the data on dynamically scheduled resources.

Aspect 23: A method for wireless communications at a receiving UE, comprising: receiving, from a transmitting UE on a sidelink channel, SCI comprising a first SCI message and a second SCI message, the sideline control information comprising one or more SPS indications pertaining to an SPS configuration for communications from the transmitting UE to the receiving UE; and transmitting, to the transmitting UE, feedback information associated with the SCI.

Aspect 24: The method of aspect 23, wherein receiving the SCI comprises: receiving, as one of the one or more SPS indications, an activation or deactivation indicator in either the first SCI message or the second SCI message, wherein the activation or deactivation indicator is indicative of the SPS configuration being either activated or deactivated, respectively.

Aspect 25: The method of any of aspects 23 through 24, wherein receiving the SCI comprises: receiving, as one of the one or more SPS indications, a configuration index in the second SCI message, wherein the configuration index is indicative of the SPS configuration.

Aspect 26: The method of any of aspects 23 through 25, wherein receiving the SCI comprises: receiving, as one of the one or more SPS indications, an SPS identifier in the first SCI message, wherein the SPS identifier is indicative that the sideline control information includes the SPS configuration.

Aspect 27: The method of aspect 26, wherein receiving the SPS identifier in the first SCI message comprises: descrambling a CRC with an SL-SPS-RNTI, wherein the SPS identifier is the scrambling of the CRC with the SL-SPS-RNTI.

Aspect 28: The method of any of aspects 23 through 27, wherein receiving the SCI comprises: receiving at least one of the one or more SPS indications in one or more fields of either the first SCI message or the second SCI message, wherein the one or more fields are configured to be used for multiple purposes.

Aspect 29: The method of aspect 28, wherein receiving the at least one of the one or more SPS indications in the one or more fields comprises: receiving each bit in a second SCI message format field of the first SCI message of “1” indicating an SPS identifier.

Aspect 30: The method of any of aspects 28 through 29, wherein receiving the at least one of the one or more SPS indications in the one or more fields comprises: receiving a new data indicator in the second SCI message of “0” and a valid frequency and time resource assignment in the second SCI message indicating activation of the SPS configuration.

Aspect 31: The method of any of aspects 28 through 30, wherein receiving the at least one of the one or more SPS indications in the one or more fields comprises: receiving a new data indicator in the second SCI message of “0” and a frequency and time resource assignment in the second SCI message of all “0”s indicating deactivation of the SPS configuration.

Aspect 32: The method of any of aspects 28 through 31, wherein receiving the at least one of the one or more SPS indications in the one or more fields comprises: receiving one or more bits of a HARQ process identifier field of the second SCI message indicating an index of the SPS configuration.

Aspect 33: The method of any of aspects 23 through 32, wherein receiving the SCI comprises: receiving at least one of the one or more SPS indications in a field of either the first SCI message or the second SCI message, wherein the field is dedicated to SPS indication use.

Aspect 34: The method of any of aspects 23 through 33, further comprising: storing the SPS configuration and the one or more SPS indications based at least in part on successfully receiving the SCI.

Aspect 35: The method of any of aspects 23 through 34, further comprising: receiving, via an additional first SCI message and an additional second SCI message, a second SCI comprising additional one or more SPS indications for modifying an active SPS configuration with the transmitting UE; and modifying the SPS configuration based at least in part on the second SCI.

Aspect 36: The method of any of aspects 23 through 35, further comprising: receiving, via at least one of an additional first SCI message or an additional second SCI message, a second SCI comprising additional one or more SPS indications for deactivating an active SPS configuration with the transmitting UE; and deactivating the SPS configuration based at least in part on the second SCI.

Aspect 37: The method of any of aspects 23 through 36, further comprising: identifying additional SPS parameters to be applied to the SPS configuration, the additional SPS parameters including at least one of a plurality of SPS configuration indices, a radio network temporary identifier for activation, deactivation, or retransmission of SPS transmissions, a periodicity of SPS transmissions, or a maximum number of times that a transport block is to be transmitted in accordance with the SPS configuration, wherein the additional SPS parameters are either received from the base station or transmitted from the transmitting UE to the receiving UE.

Aspect 38: The method of any of aspects 23 through 37, further comprising: transmitting, to the transmitting UE, a positive acknowledgement indicating the SPS configuration is active and indicating that a data transmission from the transmitting UE was successful.

Aspect 39: The method of any of aspects 23 through 38, further comprising: transmitting, to the transmitting UE, a NACK indicating the SPS configuration is active and indicating that a data transmission from the transmitting UE was unsuccessful; and receiving a retransmission of the data based at least in part on the NACK.

Aspect 40: The method of aspect 39, wherein receiving the retransmission of the data further comprises: receiving the retransmission of the data on semi-persistent scheduled resources according to the SPS configuration.

Aspect 41: The method of any of aspects 39 through 40, wherein receiving the retransmission of the data further comprises: receiving the retransmission of the data on dynamically scheduled resources.

Aspect 42: An apparatus for wireless communications at a transmitting UE, comprising a processor; memory coupled with the processor; and instructions stored in the memory and executable by the processor to cause the apparatus to perform a method of any of aspects 1 through 22.

Aspect 43: An apparatus for wireless communications at a transmitting UE, comprising at least one means for performing a method of any of aspects 1 through 22.

Aspect 44: A non-transitory computer-readable medium storing code for wireless communications at a transmitting UE, the code comprising instructions executable by a processor to perform a method of any of aspects 1 through 22.

Aspect 45: An apparatus for wireless communications at a receiving UE, comprising a processor; memory coupled with the processor; and instructions stored in the memory and executable by the processor to cause the apparatus to perform a method of any of aspects 23 through 41.

Aspect 46: An apparatus for wireless communications at a receiving UE, comprising at least one means for performing a method of any of aspects 23 through 41.

Aspect 47: A non-transitory computer-readable medium storing code for wireless communications at a receiving UE, the code comprising instructions executable by a processor to perform a method of any of aspects 23 through 41.

Although aspects of an LTE, LTE-A, LTE-A Pro, or NR system may be described for purposes of example, and LTE, LTE-A, LTE-A Pro, or NR terminology may be used in much of the description, the techniques described herein are applicable beyond LTE, LTE-A, LTE-A Pro, or NR networks. For example, the described techniques may be applicable to various other wireless communications systems such as Ultra Mobile Broadband (UMB), Institute of Electrical and Electronics Engineers (IEEE) 802.11 (Wi-Fi), IEEE 802.16 (WiMAX), IEEE 802.20, Flash-OFDM, as well as other systems and radio technologies not explicitly mentioned herein.

Information and signals described herein may be represented using any of a variety of different technologies and techniques. For example, data, instructions, commands, information, signals, bits, symbols, and chips that may be referenced throughout the description may be represented by voltages, currents, electromagnetic waves, magnetic fields or particles, optical fields or particles, or any combination thereof.

The various illustrative blocks and components described in connection with the disclosure herein may be implemented or performed with a general-purpose processor, a DSP, an ASIC, a CPU, an FPGA or other programmable logic device, discrete gate or transistor logic, discrete hardware components, or any combination thereof designed to perform the functions described herein. A general-purpose processor may be a microprocessor, but in the alternative, the processor may be any processor, controller, microcontroller, or state machine. A processor may also be implemented as a combination of computing devices (e.g., a combination of a DSP and a microprocessor, multiple microprocessors, one or more microprocessors in conjunction with a DSP core, or any other such configuration).

The functions described herein may be implemented in hardware, software executed by a processor, firmware, or any combination thereof If implemented in software executed by a processor, the functions may be stored on or transmitted over as one or more instructions or code on a computer-readable medium. Other examples and implementations are within the scope of the disclosure and appended claims. For example, due to the nature of software, functions described herein may be implemented using software executed by a processor, hardware, firmware, hardwiring, or combinations of any of these. Features implementing functions may also be physically located at various positions, including being distributed such that portions of functions are implemented at different physical locations.

Computer-readable media includes both non-transitory computer storage media and communication media including any medium that facilitates transfer of a computer program from one place to another. A non-transitory storage medium may be any available medium that may be accessed by a general-purpose or special purpose computer. By way of example, and not limitation, non-transitory computer-readable media may include RAM, ROM, electrically erasable programmable ROM (EEPROM), flash memory, compact disk (CD) ROM or other optical disk storage, magnetic disk storage or other magnetic storage devices, or any other non-transitory medium that may be used to carry or store desired program code means in the form of instructions or data structures and that may be accessed by a general-purpose or special-purpose computer, or a general-purpose or special-purpose processor. Disk and disc, as used herein, include CD, laser disc, optical disc, digital versatile disc (DVD), floppy disk and Blu-ray disc where disks usually reproduce data magnetically, while discs reproduce data optically with lasers. Combinations of the above are also included within the scope of computer-readable media.

As used herein, including in the claims, “or” as used in a list of items (e.g., a list of items prefaced by a phrase such as “at least one of” or “one or more of”) indicates an inclusive list such that, for example, a list of at least one of A, B, or C means A or B or C or AB or AC or BC or ABC (i.e., A and B and C). Also, as used herein, the phrase “based on” shall not be construed as a reference to a closed set of conditions. For example, an example step that is described as “based on condition A” may be based on both a condition A and a condition B without departing from the scope of the present disclosure. In other words, as used herein, the phrase “based on” shall be construed in the same manner as the phrase “based at least in part on.”

In the appended figures, similar components or features may have the same reference label. Further, various components of the same type may be distinguished by following the reference label by a dash and a second label that distinguishes among the similar components. If just the first reference label is used in the specification, the description is applicable to any one of the similar components having the same first reference label irrespective of the second reference label, or other subsequent reference label.

The description set forth herein, in connection with the appended drawings, describes example configurations and does not represent all the examples that may be implemented or that are within the scope of the claims. The term “example” used herein means “serving as an example, instance, or illustration,” and not “preferred” or “advantageous over other examples.” The detailed description includes specific details for the purpose of providing an understanding of the described techniques. These techniques, however, may be practiced without these specific details. In some instances, known structures and devices are shown in block diagram form in order to avoid obscuring the concepts of the described examples.

The description herein is provided to enable a person having ordinary skill in the art to make or use the disclosure. Various modifications to the disclosure will be apparent to a person having ordinary skill in the art, and the generic principles defined herein may be applied to other variations without departing from the scope of the disclosure. Thus, the disclosure is not limited to the examples and designs described herein but is to be accorded the broadest scope consistent with the principles and novel features disclosed herein.

What is claimed is:

1. A method for wireless communications at a transmitting user equipment (UE), comprising:
receiving, from a base station, a resource configuration of sidelink communications;
transmitting, to a receiving UE, sidelink control information via one or more sidelink control information messages, the sidelink control information comprising one or more semi-persistent scheduling indications pertaining to a semi-persistent scheduling configuration for communications from the transmitting UE to the receiving UE based at least in part on the resource configuration; and
monitoring for feedback information pertaining to the sidelink control information prior to proceeding with semi-persistent scheduled sidelink transmissions in accordance with the one or more semi-persistent scheduling indications.

2. The method of claim 1, wherein transmitting the sidelink control information comprises:
including, as one of the one or more semi-persistent scheduling indications, an activation or deactivation indicator in the one or more sidelink control information messages, wherein the activation or deactivation indicator is indicative of the semi-persistent scheduling configuration being either activated or deactivated, respectively.

3. The method of claim 1, wherein transmitting the sidelink control information comprises:
including, as one of the one or more semi-persistent scheduling indications, a configuration index in the one or more sidelink control information messages, wherein the configuration index is indicative of the semi-persistent scheduling configuration.

4. The method of claim 1, wherein transmitting the sidelink control information comprises:
including, as one of the one or more semi-persistent scheduling indications, a semi-persistent scheduling identifier in the one or more sidelink control information messages, wherein the semi-persistent scheduling identifier is indicative that the sidelink control information includes the semi-persistent scheduling configuration.

5. The method of claim 4, wherein including the semi-persistent scheduling identifier in the one or more sidelink control information messages comprises:
scrambling a cyclic redundancy check with a sidelink semi-persistent scheduling radio network temporary identifier (SL-SPS-RNTI), wherein the semi-persistent scheduling identifier is the scrambling of the cyclic redundancy check with the SL-SPS-RNTI.

6. The method of claim 1, wherein the one or more sidelink control information messages comprise a first sidelink control information message and a second sidelink control information message, and wherein transmitting the sidelink control information comprises:
including at least one of the one or more semi-persistent scheduling indications in one or more fields of either the first sidelink control information message or the second sidelink control information message, wherein the one or more fields are configured to be used for multiple purposes.

7. The method of claim 6, wherein including the at least one of the one or more semi-persistent scheduling indications in the one or more fields comprises:
setting each bit in a second sidelink control information message format field of the first sidelink control information message to “1” to indicate a semi-persistent scheduling identifier.

8. The method of claim 6, wherein including the at least one of the one or more semi-persistent scheduling indications in the one or more fields comprises:
setting a new data indicator in the second sidelink control information message to “0” and including a valid frequency and time resource assignment in the first sidelink control information message to indicate activation of the semi-persistent scheduling configuration.

9. The method of claim 6, wherein including the at least one of the one or more semi-persistent scheduling indications in the one or more fields comprises:
setting a new data indicator in the second sidelink control information message to “0” and setting a frequency and time resource assignment in the first sidelink control information message to all “0”s to indicate deactivation of the semi-persistent scheduling configuration.

10. The method of claim 6, wherein including the at least one of the one or more semi-persistent scheduling indications in the one or more fields comprises:
setting one or more bits of a hybrid automatic repeat request process identifier field of the second sidelink control information message to indicate an index of the semi-persistent scheduling configuration.

11. The method of claim 1, wherein transmitting the sidelink control information comprises:
including at least one of the one or more semi-persistent scheduling indications in a field of the one or more sidelink control information messages, wherein the field is dedicated to semi-persistent scheduling indication use.

12. The method of claim 1, further comprising:
receiving, from the receiving UE, a feedback message indicating the semi-persistent scheduling configuration is active based at least in part on the sidelink control information comprising the one or more semi-persistent scheduling indications.

13. The method of claim 1, further comprising:
determining, based on the feedback information, that the semi-persistent scheduling configuration is active; and
refraining from transmitting, based at least in part on the semi-persistent scheduling configuration being active, at least one of additional first sidelink control information messages or additional second sidelink control information messages in connection with downlink transmissions scheduled in accordance with the semi-persistent scheduling configuration.

14. The method of claim 13, wherein refraining from transmitting at least one of additional first sidelink control information messages or additional second sidelink control information messages in connection with downlink transmissions scheduled in accordance with the semi-persistent scheduling configuration further comprises:
refraining from transmitting both additional first sidelink control information messages and additional second sidelink control information messages in connection with downlink transmissions scheduled in accordance with the semi-persistent scheduling configuration based at least in part on the UE operating in a first sidelink mode.

15. The method of claim 13, wherein refraining from transmitting at least one of additional first sidelink control information messages or additional second sidelink control information messages in connection with downlink transmissions scheduled in accordance with the semi-persistent scheduling configuration further comprises:
refraining from transmitting additional second sidelink control information messages while still transmitting additional first sidelink control information messages in connection with downlink transmissions scheduled in accordance with the semi-persistent scheduling configuration based at least in part on the UE operating in a second sidelink mode.

16. The method of claim 1, further comprising:
determining that the semi-persistent scheduling configuration is to be updated; and
transmitting, to the receiving UE and via one or more additional sidelink control information messages, a second sidelink control information comprising additional one or more semi-persistent scheduling indications for modifying an active semi-persistent scheduling configuration with the receiving UE.

17. The method of claim 1, further comprising:
determining that the semi-persistent scheduling configuration is to be deactivated; and
transmitting, to the receiving UE and via one or more additional sidelink control information messages, a second sidelink control information comprising additional one or more semi-persistent scheduling indications for deactivating an active semi-persistent scheduling configuration with the receiving UE.

18. The method of claim 1, further comprising:
identifying additional semi-persistent scheduling parameters to be applied to the semi-persistent scheduling configuration, the additional semi-persistent scheduling parameters including at least one of a plurality of semi-persistent scheduling configuration indices, a radio network temporary identifier for activation, deactivation, or retransmission of semi-persistent scheduling transmissions, a periodicity of semi-persistent scheduling transmissions, or a maximum number of times that a transport block is to be transmitted in accordance with the semi-persistent scheduling configuration, wherein the additional semi-persistent scheduling parameters are either received from the base station or transmitted from the transmitting UE to the receiving UE.

19. The method of claim 1, further comprising:
receiving, from the receiving UE, a positive acknowledgement indicating the semi-persistent scheduling configuration is active and indicating that a data transmission from the transmitting UE was successful.

20. The method of claim 1, further comprising:
receiving, from the receiving UE, a negative acknowledgement indicating the semi-persistent scheduling configuration is active and indicating that a data transmission from the transmitting UE was unsuccessful; and
transmitting a retransmission of the data based at least in part on the negative acknowledgement.

21. The method of claim 20, wherein transmitting the retransmission of the data further comprises:
transmitting the retransmission of the data on semi-persistent scheduled resources according to the semi-persistent scheduling configuration.

22. The method of claim 20, wherein transmitting the retransmission of the data further comprises:
transmitting the retransmission of the data on dynamically scheduled resources.

23. An apparatus for wireless communications at a transmitting user equipment (UE), comprising:
a processor,
memory coupled with the processor; and
instructions stored in the memory and executable by the processor to cause the apparatus to:
receive, from a base station, a resource configuration of sidelink communications;
transmit, to a receiving UE, sidelink control information via one or more sidelink control information messages, the sidelink control information comprising one or more semi-persistent scheduling indications pertaining to a semi-persistent scheduling configuration for communications from the transmitting UE to the receiving UE based at least in part on the resource configuration; and
monitor for feedback information pertaining to the sidelink control information prior to proceeding with semi-persistent scheduled sidelink transmissions in accordance with the one or more semi-persistent scheduling indications.

24. The apparatus of claim 23, wherein the instructions to transmit the sidelink control information are executable by the processor to cause the apparatus to:
include, as one of the one or more semi-persistent scheduling indications, an activation or deactivation indicator in the one or more sidelink control information messages, wherein the activation or deactivation indicator is indicative of the semi-persistent scheduling configuration being either activated or deactivated, respectively.

25. The apparatus of claim 23, wherein the instructions to transmit the sidelink control information are executable by the processor to cause the apparatus to:
include, as one of the one or more semi-persistent scheduling indications, a configuration index in the one or more sidelink control information messages, wherein the configuration index is indicative of the semi-persistent scheduling configuration.

26. The apparatus of claim 23, wherein the instructions to transmit the sidelink control information are executable by the processor to cause the apparatus to:
include, as one of the one or more semi-persistent scheduling indications, a semi-persistent scheduling identifier in the one or more sidelink control information messages, wherein the semi-persistent scheduling identifier is indicative that the sidelink control information includes the semi-persistent scheduling configuration.

27. The apparatus of claim 26, wherein the instructions to include the semi-persistent scheduling identifier in the one or more sidelink control information messages are executable by the processor to cause the apparatus to:
scramble a cyclic redundancy check with a sidelink semi-persistent scheduling radio network temporary identifier (SL-SPS-RNTI), wherein the semi-persistent scheduling identifier is the scrambling of the cyclic redundancy check with the SL-SPS-RNTI.

28. The apparatus of claim 23, wherein the one or more sidelink control information messages comprise a first sidelink control information message and a second sidelink control information message, and wherein the instructions to transmit the sidelink control information are executable by the processor to cause the apparatus to:
include at least one of the one or more semi-persistent scheduling indications in one or more fields of either the first sidelink control information message or the second sidelink control information message, wherein the one or more fields are configured to be used for multiple purposes.

29. The apparatus of claim 28, wherein the instructions to include the at least one of the one or more semi-persistent scheduling indications in the one or more fields are executable by the processor to cause the apparatus to:
set each bit in a second sidelink control information message format field of the first sidelink control information message to “1” to indicate a semi-persistent scheduling identifier.

30. The apparatus of claim 28, wherein the instructions to include the at least one of the one or more semi-persistent scheduling indications in the one or more fields are executable by the processor to cause the apparatus to:
set a new data indicator in the second sidelink control information message to “0” and including a valid frequency and time resource assignment in the first sidelink control information message to indicate activation of the semi-persistent scheduling configuration.

31. The apparatus of claim 28, wherein the instructions to include the at least one of the one or more semi-persistent scheduling indications in the one or more fields are executable by the processor to cause the apparatus to:
set a new data indicator in the second sidelink control information message to “0” and setting a frequency and time resource assignment in the first sidelink control information message to all “0”s to indicate deactivation of the semi-persistent scheduling configuration.

32. The apparatus of claim 28, wherein the instructions to include the at least one of the one or more semi-persistent scheduling indications in the one or more fields are executable by the processor to cause the apparatus to:
set one or more bits of a hybrid automatic repeat request process identifier field of the second sidelink control information message to indicate an index of the semi-persistent scheduling configuration.

33. The apparatus of claim 23, wherein the instructions to transmit the sidelink control information are executable by the processor to cause the apparatus to:
include at least one of the one or more semi-persistent scheduling indications in a field of the one or more sidelink control information messages, wherein the field is dedicated to semi-persistent scheduling indication use.

34. The apparatus of claim 23, wherein the instructions are further executable by the processor to cause the apparatus to:
receive, from the receiving UE, a feedback message indicating the semi-persistent scheduling configuration is active based at least in part on the sidelink control information comprising the one or more semi-persistent scheduling indications.

35. The apparatus of claim 23, wherein the instructions are further executable by the processor to cause the apparatus to:
determine, based on the feedback information, that the semi-persistent scheduling configuration is active; and
refrain from transmitting, based at least in part on the semi-persistent scheduling configuration being active, at least one of additional first sidelink control information messages or additional second sidelink control information messages in connection with downlink transmissions scheduled in accordance with the semi-persistent scheduling configuration.

36. The apparatus of claim 35, wherein the instructions to refrain from transmitting at least one of additional first sidelink control information messages or additional second sidelink control information messages in connection with downlink transmissions scheduled in accordance with the semi-persistent scheduling configuration further are executable by the processor to cause the apparatus to:
refrain from transmitting both additional first sidelink control information messages and additional second sidelink control information messages in connection with downlink transmissions scheduled in accordance with the semi-persistent scheduling configuration based at least in part on the UE operating in a first sidelink mode.

37. The apparatus of claim 35, wherein the instructions to refrain from transmitting at least one of additional first sidelink control information messages or additional second sidelink control information messages in connection with downlink transmissions scheduled in accordance with the semi-persistent scheduling configuration further are executable by the processor to cause the apparatus to:
refrain from transmitting additional second sidelink control information messages while still transmitting additional first sidelink control information messages in connection with downlink transmissions scheduled in accordance with the semi-persistent scheduling configuration based at least in part on the UE operating in a second sidelink mode.

38. The apparatus of claim 23, wherein the instructions are further executable by the processor to cause the apparatus to:
determine that the semi-persistent scheduling configuration is to be updated; and
transmit, to the receiving UE and via one or more additional sidelink control information messages, a second sidelink control information comprising additional one or more semi-persistent scheduling indications for modifying an active semi-persistent scheduling configuration with the receiving UE.

39. The apparatus of claim 23, wherein the instructions are further executable by the processor to cause the apparatus to:
determine that the semi-persistent scheduling configuration is to be deactivated; and
transmit, to the receiving UE and via one or more additional sidelink control information messages, a second sidelink control information comprising additional one or more semi-persistent scheduling indications for deactivating an active semi-persistent scheduling configuration with the receiving UE.

40. The apparatus of claim 23, wherein the instructions are further executable by the processor to cause the apparatus to:
identify additional semi-persistent scheduling parameters to be applied to the semi-persistent scheduling configuration, the additional semi-persistent scheduling parameters including at least one of a plurality of semi-persistent scheduling configuration indices, a radio network temporary identifier for activation, deactivation, or retransmission of semi-persistent scheduling transmissions, a periodicity of semi-persistent scheduling transmissions, or a maximum number of times that a transport block is to be transmitted in accordance with the semi-persistent scheduling configuration, wherein the additional semi-persistent scheduling parameters are either received from the base station or transmitted from the transmitting UE to the receiving UE.

41. The apparatus of claim 23, wherein the instructions are further executable by the processor to cause the apparatus to:
receive, from the receiving UE, a positive acknowledgement indicating the semi-persistent scheduling configuration is active and indicating that a data transmission from the transmitting UE was successful.

42. The apparatus of claim 23, wherein the instructions are further executable by the processor to cause the apparatus to:
receive, from the receiving UE, a negative acknowledgement indicating the semi-persistent scheduling configuration is active and indicating that a data transmission from the transmitting UE was unsuccessful; and
transmit a retransmission of the data based at least in part on the negative acknowledgement.

43. The apparatus of claim 42, wherein the instructions to transmit the retransmission of the data further are executable by the processor to cause the apparatus to:
transmit the retransmission of the data on semi-persistent scheduled resources according to the semi-persistent scheduling configuration.

44. The apparatus of claim 42, wherein the instructions to transmit the retransmission of the data further are executable by the processor to cause the apparatus to:
transmit the retransmission of the data on dynamically scheduled resources.

45. An apparatus for wireless communications at a transmitting user equipment (UE), comprising:
means for receiving, from a base station, a resource configuration of sidelink communications;
means for transmitting, to a receiving UE, sidelink control information via one or more sidelink control information messages, the sidelink control information comprising one or more semi-persistent scheduling indications pertaining to a semi-persistent scheduling configuration for communications from the transmitting UE to the receiving UE based at least in part on the resource configuration; and
means for monitoring for feedback information pertaining to the sidelink control information prior to proceeding with semi-persistent scheduled sidelink transmissions in accordance with the one or more semi-persistent scheduling indications.

46. The apparatus of claim 45, wherein the means for transmitting the sidelink control information comprises:
means for including, as one of the one or more semi-persistent scheduling indications, an activation or deactivation indicator in the one or more sidelink control information messages, wherein the activation or deactivation indicator is indicative of the semi-persistent scheduling configuration being either activated or deactivated, respectively.

47. The apparatus of claim 45, wherein the means for transmitting the sidelink control information comprises:
means for including, as one of the one or more semi-persistent scheduling indications, a configuration index in the one or more sidelink control information messages, wherein the configuration index is indicative of the semi-persistent scheduling configuration.

48. The apparatus of claim 45, wherein the means for transmitting the sidelink control information comprises:
means for including, as one of the one or more semi-persistent scheduling indications, a semi-persistent scheduling identifier in the one or more sidelink control information message, wherein the semi-persistent scheduling identifier is indicative that the sidelink control information includes the semi-persistent scheduling configuration.

49. A non-transitory computer-readable medium storing code for wireless communications at a transmitting user equipment (UE), the code comprising instructions executable by a processor to:
receive, from a base station, a resource configuration of sidelink communications;
transmit, to a receiving UE, sidelink control information via one or more sidelink control information messages, the sidelink control information comprising one or more semi-persistent scheduling indications pertaining to a semi-persistent scheduling configuration for communications from the transmitting UE to the receiving UE based at least in part on the resource configuration; and
monitor for feedback information pertaining to the sidelink control information prior to proceeding with semi-persistent scheduled sidelink transmissions in accordance with the one or more semi-persistent scheduling indications.

50. The non-transitory computer-readable medium of claim 49, wherein the instructions to transmit the sidelink control information are executable to:
include, as one of the one or more semi-persistent scheduling indications, an activation or deactivation indicator in the one or more sidelink control information messages, wherein the activation or deactivation indicator is indicative of the semi-persistent scheduling configuration being either activated or deactivated, respectively.

51. The non-transitory computer-readable medium of claim 49, wherein the instructions to transmit the sidelink control information are executable to:
include, as one of the one or more semi-persistent scheduling indications, a configuration index in the one or more sidelink control information messages, wherein the configuration index is indicative of the semi-persistent scheduling configuration.

52. The non-transitory computer-readable medium of claim 49, wherein the instructions to transmit the sidelink control information are executable to:
include, as one of the one or more semi-persistent scheduling indications, a semi-persistent scheduling identifier in the one or more sidelink control information messages, wherein the semi-persistent scheduling identifier is indicative that the sidelink control information includes the semi-persistent scheduling configuration.
